(19) United States
(12) Patent Application Publication
(10) Pub. No.: US 2023/0292252 A1
(43) Pub. Date: Sep. 14, 2023

(54) MAXIMUM TRANSMIT POWER INDICATION FOR BANDWIDTHS ABOVE 160 MHZ OR FOR PUNCTURED BANDWIDTHS

(71) Applicant: QUALCOMM Incorporated, San Diego, CA (US)

(72) Inventors: Yanjun SUN, San Diego, CA (US); Alfred ASTERJADHI, San Diego, CA (US); George CHERIAN, San Diego, CA (US); Abhishek Pramod PATIL, San Diego, CA (US); Sai Yiu Duncan HO, San Diego, CA (US); Gaurang NAIK, San Diego, CA (US); Abdel Karim AJAMI, San Diego, CA (US)

(21) Appl. No.: 18/181,365

(22) Filed: Mar. 9, 2023

Related U.S. Application Data
(60) Provisional application No. 63/269,284, filed on Mar. 14, 2022.

(51) Int. Cl. H04W 52/18; H04W 52/36; H04L 1/00

(52) U.S. Cl. CPC H04W 52/18; H04W 52/367; H04L 1/0013

(57) ABSTRACT

Various aspects of the present disclosure generally relate to wireless communication. In some aspects, a network entity may generate a transmit power envelope (TPE) element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode. The network entity may transmit the TPE element. Numerous other aspects are described.

### CROSS-REFERENCE TO RELATED APPLICATION

This patent application claims priority to U.S. Provisional Patent Application No. 63/269,284, filed on Mar. 14, 2022, entitled “MAXIMUM TRANSMIT POWER INDICATION FOR BANDWIDTHS ABOVE 160 MHZ OR FOR PUNCTURED BANDWIDTHS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for indicating a maximum transmit power for bandwidths above 160 MHz or for punctured bandwidths.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network entity. The method may include generating a transmit power envelope (TPE) element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode. The method may include transmitting the TPE element.

Some aspects described herein relate to a method of wireless communication performed by a wireless device. The method may include receiving a TPE element that includes fields that indicate maximum transmit powers for bandwidth sizes, including an extension field for a bandwidth whose size is greater than 160 MHz or for a bandwidth with channel puncturing. The method may include decoding the extension field of the TPE element based at least in part on a first bandwidth size configured for the wireless device, whether the first bandwidth size includes channel puncturing, or one or more parameters in the TPE element. The method may include transmitting a communication using a maximum transmit power indicated in the extension field.

Some aspects described herein relate to a method of wireless communication performed by a network entity. The method may include generating a TPE element that includes power spectral density (PSD) values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode. The method may include transmitting the TPE element.

Some aspects described herein relate to a method of wireless communication performed by a wireless device. The method may include receiving a TPE element that includes PSD values that indicate maximum PSDs for bandwidth sizes, including extended PSD values for a bandwidth whose size is greater than 160 MHz or for a bandwidth with channel puncturing. The method may include decoding the extended PSD values of the TPE element based at least in part on a first bandwidth size configured for the wireless device, whether the first bandwidth size includes channel puncturing, or one or more parameters in the TPE element. The method may include transmitting a communication using maximum transmit PSDs indicated by the extended PSD values.

Some aspects described herein relate to a method of wireless communication performed by a network entity. The method may include generating a first TPE element that includes one or more fields that indicate maximum transmit powers for bandwidth sizes, including a field for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The method may include transmitting the first TPE element.

Some aspects described herein relate to a method of wireless communication performed by a network entity. The method may include generating a first TPE element that includes PSD values that indicate maximum PSDs for bandwidth sizes, including PSD values for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The method may include transmitting the first TPE element.

Some aspects described herein relate to a network entity for wireless communication. The network entity may include a memory and one or more processors coupled to the memory. The one or more processors may be configured to generate a TPE element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode. The one or more processors may be configured to transmit the TPE element.

Some aspects described herein relate to a wireless device for wireless communication. The wireless device may include a memory and one or more processors coupled to the memory. The one or more processors may be configured to receive a TPE element that includes fields that indicate maximum transmit powers for bandwidth sizes, including an extension field for a bandwidth whose size is greater than 160 MHz or for a bandwidth with channel puncturing. The one or more processors may be configured to decode the extension field of the TPE element based at least in part on a first bandwidth size configured for the wireless device, whether the first bandwidth size includes channel puncturing, or one or more parameters in the TPE element. The one or more processors may be configured to transmit a communication using a maximum transmit power indicated in the extension field.

Some aspects described herein relate to a network entity for wireless communication. The network entity may include a memory and one or more processors coupled to the memory. The one or more processors may be configured to generate a TPE element that includes PSD values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode. The one or more processors may be configured to transmit the TPE element.

Some aspects described herein relate to a wireless device for wireless communication. The wireless device may include a memory and one or more processors coupled to the memory. The one or more processors may be configured to receive a TPE element that includes PSD values that indicate maximum PSDs for bandwidth sizes, including extended PSD values for a bandwidth whose size is greater than 160 MHz or for a bandwidth with channel puncturing. The one or more processors may be configured to decode the extended PSD values of the TPE element based at least in part on a first bandwidth size configured for the wireless device, whether the first bandwidth size includes channel puncturing, or one or more parameters in the TPE element. The one or more processors may be configured to transmit a communication using maximum transmit PSDs indicated by the extended PSD values.

Some aspects described herein relate to a network entity for wireless communication. The network entity may include a memory and one or more processors coupled to the memory. The one or more processors may be configured to generate a first TPE element that includes one or more fields that indicate maximum transmit powers for bandwidth sizes, including a field for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The one or more processors may be configured to transmit the first TPE element.

Some aspects described herein relate to a network entity for wireless communication. The network entity may include a memory and one or more processors coupled to the memory. The one or more processors may be configured to generate a first TPE element that includes PSD values that indicate maximum PSDs for bandwidth sizes, including PSD values for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The one or more processors may be configured to transmit the first TPE element.

Some aspects described herein relate to a non-transitory computer-readable medium that stores a set of instructions for wireless communication by a network entity. The set of instructions, when executed by one or more processors of the network entity, may cause the network entity to generate a TPE element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode. The set of instructions, when executed by one or more processors of the network entity, may cause the network entity to transmit the TPE element.

Some aspects described herein relate to a non-transitory computer-readable medium that stores a set of instructions for wireless communication by a wireless device. The set of instructions, when executed by one or more processors of the wireless device, may cause the wireless device to receive a TPE element that includes fields that indicate maximum transmit powers for bandwidth sizes, including an extension field for a bandwidth whose size is greater than 160 MHz or for a bandwidth with channel puncturing. The set of instructions, when executed by one or more processors of the wireless device, may cause the wireless device to decode the extension field of the TPE element based at least in part on a first bandwidth size configured for the wireless device, whether the first bandwidth size includes channel puncturing, or one or more parameters in the TPE element. The set of instructions, when executed by one or more processors of the wireless device, may cause the wireless device to transmit a communication using a maximum transmit power indicated in the extension field.

Some aspects described herein relate to a non-transitory computer-readable medium that stores a set of instructions for wireless communication by a network entity. The set of instructions, when executed by one or more processors of the network entity, may cause the network entity to generate a TPE element that includes PSD values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode. The set of instructions, when executed by one or more processors of the network entity, may cause the network entity to transmit the TPE element.

Some aspects described herein relate to a non-transitory computer-readable medium that stores a set of instructions for wireless communication by a wireless device. The set of instructions, when executed by one or more processors of the wireless device, may cause the wireless device to receive a TPE element that includes PSD values that indicate maximum PSDs for bandwidth sizes, including extended PSD values for a bandwidth whose size is greater than 160 MHz or for a bandwidth with channel puncturing. The set of instructions, when executed by one or more processors of the wireless device, may cause the wireless device to decode the extended PSD values of the TPE element based at least in part on a first bandwidth size configured for the wireless device, whether the first bandwidth size includes channel puncturing, or one or more parameters in the TPE element. The set of instructions, when executed by one or more processors of the wireless device, may cause the wireless device to transmit a communication using maximum transmit PSDs indicated by the extended PSD values.

Some aspects described herein relate to a non-transitory computer-readable medium that stores a set of instructions for wireless communication by a network entity. The set of instructions, when executed by one or more processors of the network entity, may cause the network entity to generate a first TPE element that includes one or more fields that indicate maximum transmit powers for bandwidth sizes, including a field for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The set of instructions, when executed by one or more processors of the network entity, may cause the network entity to transmit the first TPE element.

Some aspects described herein relate to a non-transitory computer-readable medium that stores a set of instructions for wireless communication by a network entity. The set of instructions, when executed by one or more processors of the network entity, may cause the network entity to generate a first TPE element that includes PSD values that indicate maximum PSDs for bandwidth sizes, including PSD values for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The set of instructions, when executed by one or more processors of the network entity, may cause the network entity to transmit the first TPE element.

Some aspects described herein relate to an apparatus for wireless communication. The apparatus may include means for generating a TPE element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode. The apparatus may include means for transmitting the TPE element.

Some aspects described herein relate to an apparatus for wireless communication. The apparatus may include means for receiving a TPE element that includes fields that indicate maximum transmit powers for bandwidth sizes, including an extension field for a bandwidth whose size is greater than 160 MHz or for a bandwidth with channel puncturing. The apparatus may include means for decoding the extension field of the TPE element based at least in part on a first bandwidth size configured for the wireless device, whether the first bandwidth size includes channel puncturing, or one or more parameters in the TPE element. The apparatus may include means for transmitting a communication using a maximum transmit power indicated in the extension field.

Some aspects described herein relate to an apparatus for wireless communication. The apparatus may include means for generating a TPE element that includes PSD values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode. The apparatus may include means for transmitting the TPE element.

Some aspects described herein relate to an apparatus for wireless communication. The apparatus may include means for receiving a TPE element that includes PSD values that indicate maximum PSDs for bandwidth sizes, including extended PSD values for a bandwidth whose size is greater than 160 MHz or for a bandwidth with channel puncturing. The apparatus may include means for decoding the extended PSD values of the TPE element based at least in part on a first bandwidth size configured for the wireless device, whether the first bandwidth size includes channel puncturing, or one or more parameters in the TPE element. The apparatus may include means for transmitting a communication using maximum transmit PSDs indicated by the extended PSD values.

Some aspects described herein relate to an apparatus for wireless communication. The apparatus may include means for generating a first TPE element that includes one or more fields that indicate maximum transmit powers for bandwidth sizes, including a field for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The apparatus may include means for transmitting the first TPE element.

Some aspects described herein relate to an apparatus for wireless communication. The apparatus may include means for generating a first TPE element that includes PSD values that indicate maximum PSDs for bandwidth sizes, including PSD values for a bandwidth whose size is greater than 160 MHz or for a bandwidth with channel puncturing, wherein the first TPE element includes one or more of a control field or a value of 4 or greater in a maximum transmit power interpretation subfield associated with the first TPE element. The apparatus may include means for transmitting the first TPE element.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIG. 3 is a diagram illustrating an example of a disaggregated base station, in accordance with the present disclosure.

FIG. 4 is a diagram illustrating an example of a transmit power envelope (TPE) format, in accordance with the present disclosure.

FIG. 5 is a diagram illustrating an example of indicating a maximum transmit power for bandwidths with a size greater than 160 MHz or for a bandwidth that is punctured, in accordance with the present disclosure.

FIG. 6 is a diagram illustrating another example of indicating a maximum transmit power for bandwidths with a size greater than 160 MHz or for a bandwidth that is punctured, in accordance with the present disclosure.

FIG. 7 is a diagram illustrating an example process performed, for example, by a network entity, in accordance with the present disclosure.

FIG. 8 is a diagram illustrating an example process performed, for example, by a UE, in accordance with the present disclosure.

FIG. 9 is a diagram illustrating an example process performed, for example, by a network entity, in accordance with the present disclosure.

FIG. 10 is a diagram illustrating an example process performed, for example, by a UE, in accordance with the present disclosure.

FIG. 11 is a diagram illustrating an example process performed, for example, by a network entity, in accordance with the present disclosure.

FIG. 12 is a diagram illustrating an example process performed, for example, by a UE, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT) or access points (AP) that operate according to International Institute of Electronics Engineers (IEEE) standards (e.g., 802) standards, aspects of the present disclosure can be applied to other RATs, such as a 3G RAT, a 4G RAT, a RAT subsequent to 5G (e.g., 6G), or other ultra-wideband (UWB) standards.

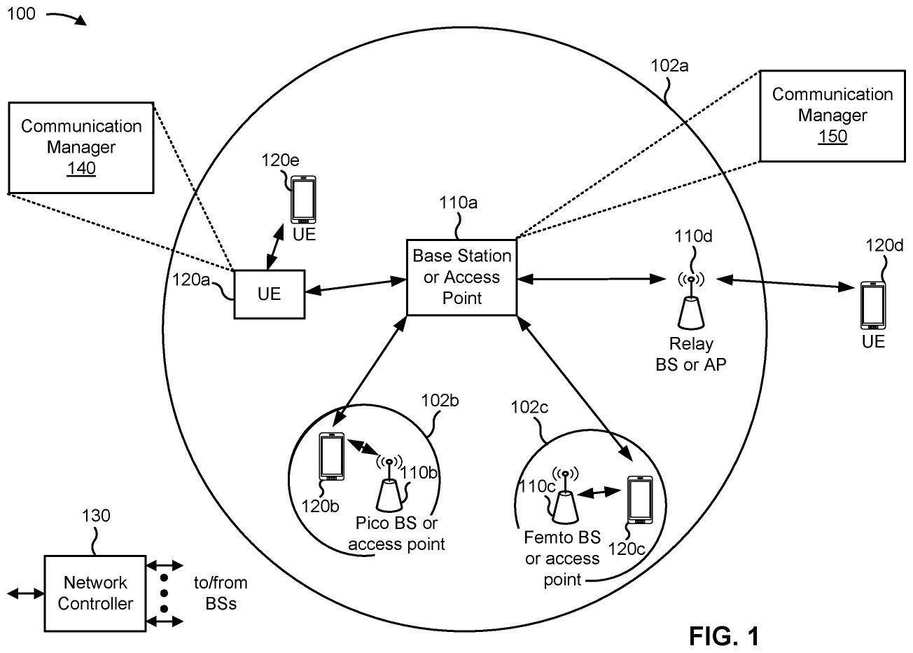

FIG. 1 is a diagram illustrating an example of a wireless network 100, in accordance with the present disclosure. The wireless network 100 may be or may include elements of a 5G (e.g., NR) network, a 4G (e.g., Long Term Evolution (LTE)) network, wide area network (WAN) APs, personal area network (PAN) APs, UWB APs, among other examples. The wireless network 100 may include a user equipment (UE) 120 or multiple UEs 120 (shown as a UE 120a, a UE 120b, a UE 120c, a UE 120d, and a UE 120e). A UE 120 in some UWB networks may be referred to as a “station” (STA). The wireless network 100 may also include one or more network entities, such as a base station or access point 110 (shown as BS or AP 110a, pico BS or AP 110b, femto BS or AP 110c, and relay BS or AP 110d) and/or other network entities. A base station or AP 110 is a network entity that communicates with UEs 120. A base station or AP 110 (sometimes referred to as a BS) may include, for example, an NR base station, an LTE base station, a Node B, an eNB (e.g., in 4G), a gNB (e.g., in 5G), a WAN AP, a PAN AP, and/or a transmission reception point (TRP). Each base station or AP 110 may provide communication coverage for a particular geographic area. The term “cell” can refer to a coverage area of a base station or AP 110, an access point, and/or a base station subsystem serving this coverage area, depending on the context in which the term is used.

A base station or AP 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station for a macro cell may be referred to as a macro base station. A base station for a pico cell may be referred to as a pico base station. A base station for a femto cell may be referred to as a femto base station or an in-home base station. In the example shown in FIG. 1, the BS or AP 110a may be a macro base station or AP for a macro cell 102a, the BS or AP 110b may be a pico base station or AP for a pico cell 102b, and the BS or AP 110c may be a femto base station or AP for a femto cell 102c. A base station may support one or multiple (e.g., three) cells.

In some examples, a cell may not necessarily be stationary, and the geographic area of the cell may move according to the location of a base station or AP 110 that is mobile (e.g., a mobile base station). In some examples, the base stations or APs 110 may be interconnected to one another and/or to one or more other base stations or APs 110 or network entities in the wireless network 100 through various types of backhaul interfaces, such as a direct physical connection or a virtual network, using any suitable transport network.

In some aspects, the term “base station” or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station or AP 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station. A WAN access point, a PAN access point, or an UWB access point may also be referred to as a “network entity.” A network entity may include components described for the base station or AP 110.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS or AP 110d (e.g., a relay base station) may communicate with the BS or AP 110a (e.g., a macro base station, access point) and the UE 120d in order to facilitate communication between the BS or AP 110a and the UE 120d. A base station that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations or APs 110 may have different transmit power levels, different coverage areas, and/or different impacts on interference in the wireless network 100. For example, macro base stations or APs may have a high transmit power level (e.g., 5 to 40 watts) whereas pico base stations or APs, femto base stations or APs, and relay base stations or APs may have lower transmit power levels (e.g., 0.1 to 2 watts).

A network controller 130 may couple to or communicate with a set network entities and may provide coordination and control for these network entities. The network controller 130 may communicate with the base stations or APs 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, STA, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station or AP 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. A UWB frequency bandwidth may be up to 160 MHz, up to 320 MHz, or even greater than 500 MHz. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network entity (e.g., base station or AP 110) may include a communication manager 150. As described in more detail elsewhere herein, the communication manager 150 may generate a transmit power envelope (TPE) element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode. The communication manager 150 may transmit the TPE element.

In some aspects, the communication manager 150 may generate a TPE element that includes power spectral density (PSD) values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode. The communication manager 150 may transmit the TPE element.

In some aspects, the communication manager 150 may generate a first TPE element that includes one or more fields that indicate maximum transmit powers for bandwidth sizes, including a field for a bandwidth whose size is greater than 160 MHz or for a bandwidth with channel puncturing, where the first TPE element includes one or more of a control field or a value of 4 or greater in a maximum transmit power interpretation subfield associated with the first TPE element. The communication manager 150 may transmit the first TPE element.

In some aspects, the communication manager 150 may generate a first TPE element that includes PSD values that indicate maximum PSDs for bandwidth sizes, including PSD values for a bandwidth whose size is greater than 160 MHz or for a bandwidth with channel puncturing, where the first TPE element includes one or more of a control field or a value of 4 or greater in a maximum transmit power interpretation subfield associated with the first TPE element. The communication manager 150 may transmit the TPE element. Additionally, or alternatively, the communication manager 150 may perform one or more other operations described herein.

In some aspects, a wireless device (e.g., a UE 120, a STA) may include a communication manager 140. As described in more detail elsewhere herein, the communication manager 140 may receive a TPE element that includes fields that indicate maximum transmit powers for bandwidth sizes, including an extension field for a bandwidth whose size is greater than 160 MHz or for a bandwidth with channel puncturing. The communication manager 140 may decode the extension field of the TPE element based at least in part on a first bandwidth size configured for the wireless device, whether the first bandwidth size includes channel puncturing, or one or more parameters in the TPE element. The communication manager 140 may transmit a communication using a maximum transmit power indicated in the extension field.

In some aspects, the communication manager 140 may receive a TPE element that includes PSD values that indicate maximum PSDs for bandwidth sizes, including extended PSD values for a bandwidth whose size is greater than 160 MHz or for a bandwidth with channel puncturing. The communication manager 140 may decode the extended PSD values of the TPE element based at least in part on a first bandwidth size configured for the wireless device, whether the first bandwidth size includes channel puncturing, or one or more parameters in the TPE element. The communication manager 140 may transmit a communication using maximum transmit PSDs indicated by the extended PSD values. Additionally, or alternatively, the communication manager 140 may perform one or more other operations described herein.

As indicated above, FIG. 1 is provided as an example. Other examples may differ from what is described with regard to FIG. 1.

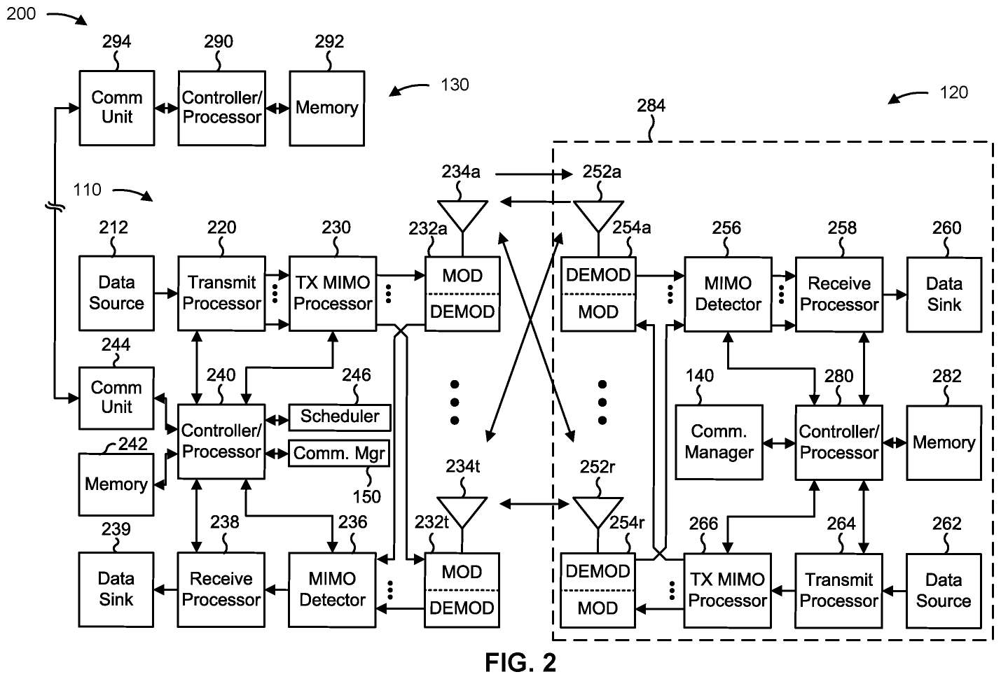

FIG. 2 is a diagram illustrating an example 200 of a network entity (e.g., base station or AP 110) in communication with a UE 120 in a wireless network 100, in accordance with the present disclosure. The base station or AP 110 may be equipped with a set of antennas 234a through 234t, such as T antennas (T≥1). The UE 120 may be equipped with a set of antennas 252a through 252r, such as R antennas (R≥1). The network entity may be a WAN AP that includes components as described for the base station or AP 110 and that operates in accordance with IEEE standards (e.g., IEEE 802).

At the base station or AP 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station or AP 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station or AP 110 and/or other base stations or APs 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

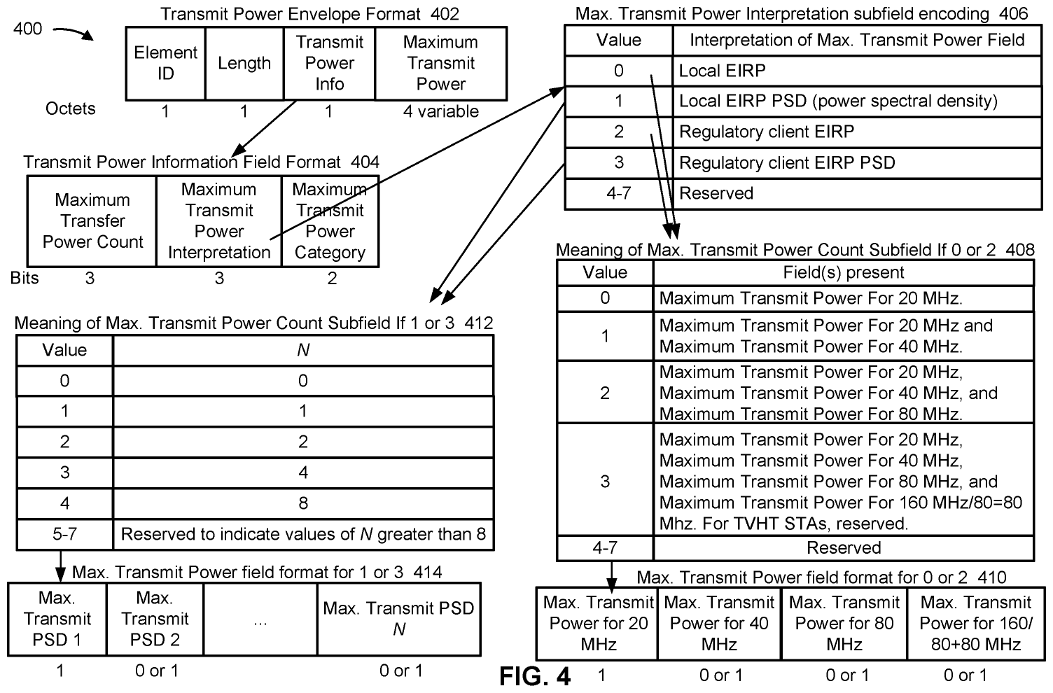

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network entity (e.g., base station or AP 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

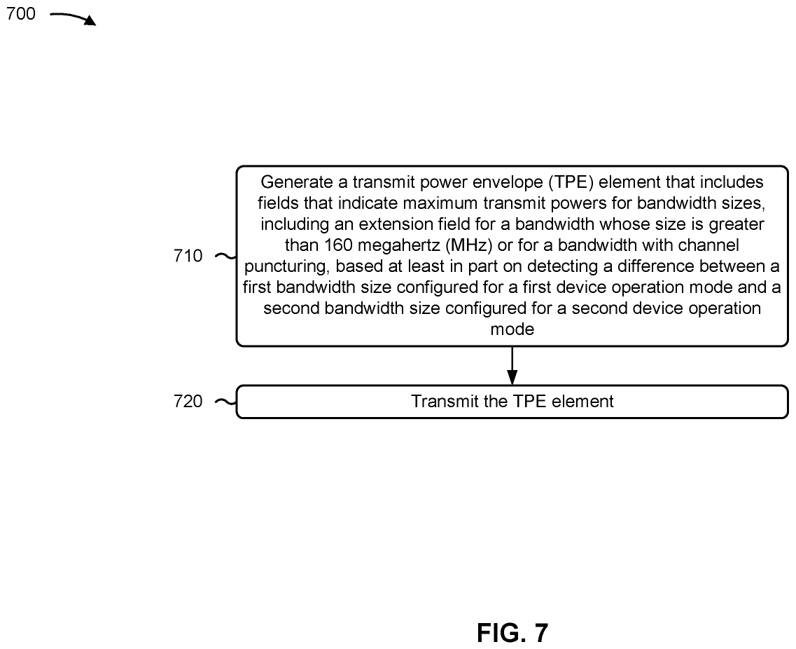

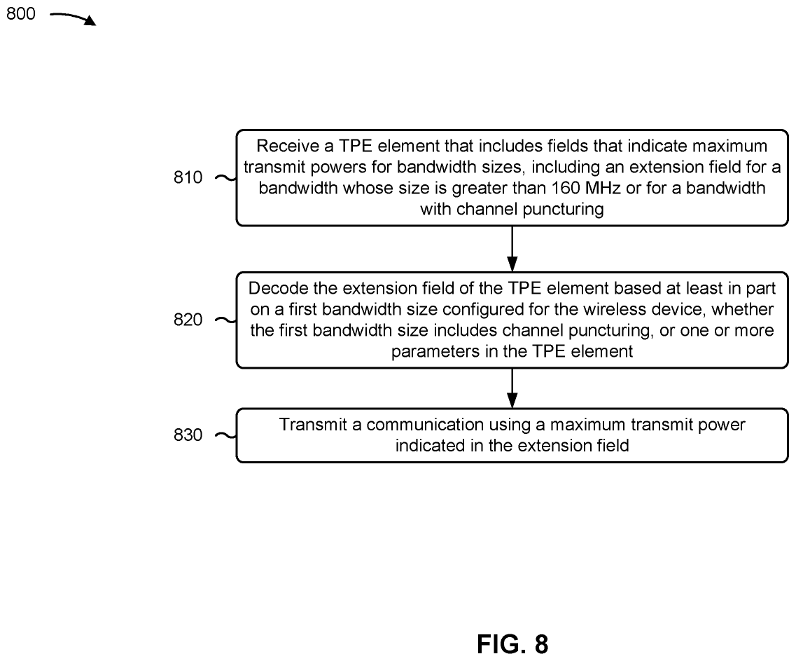

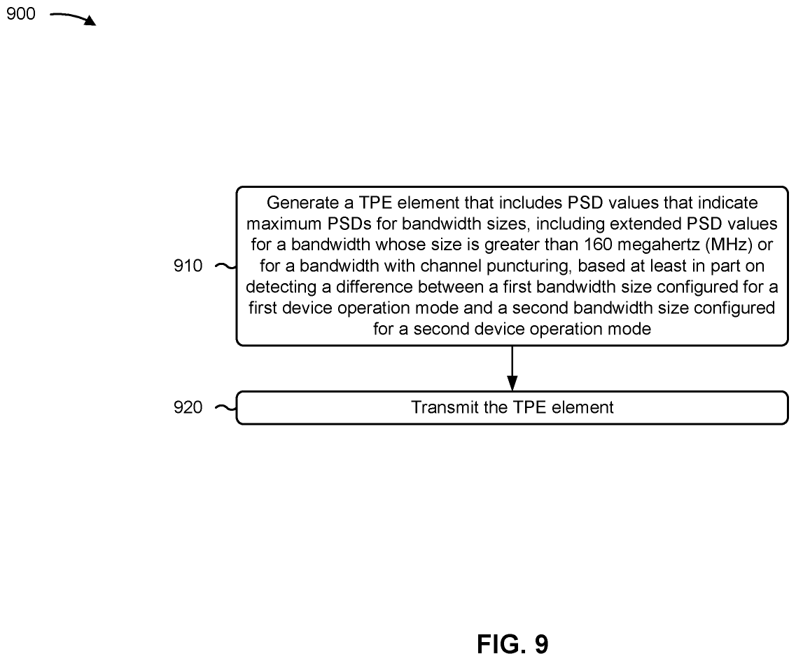

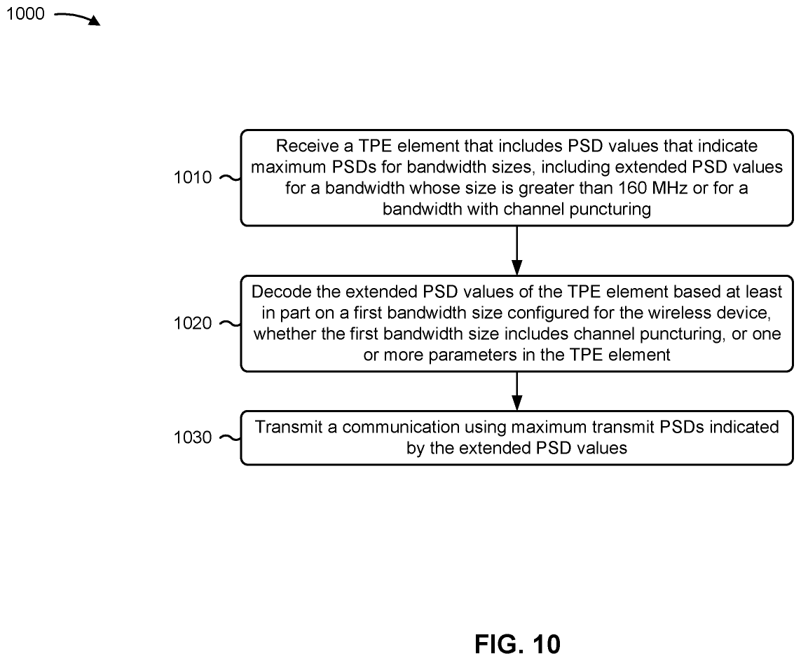

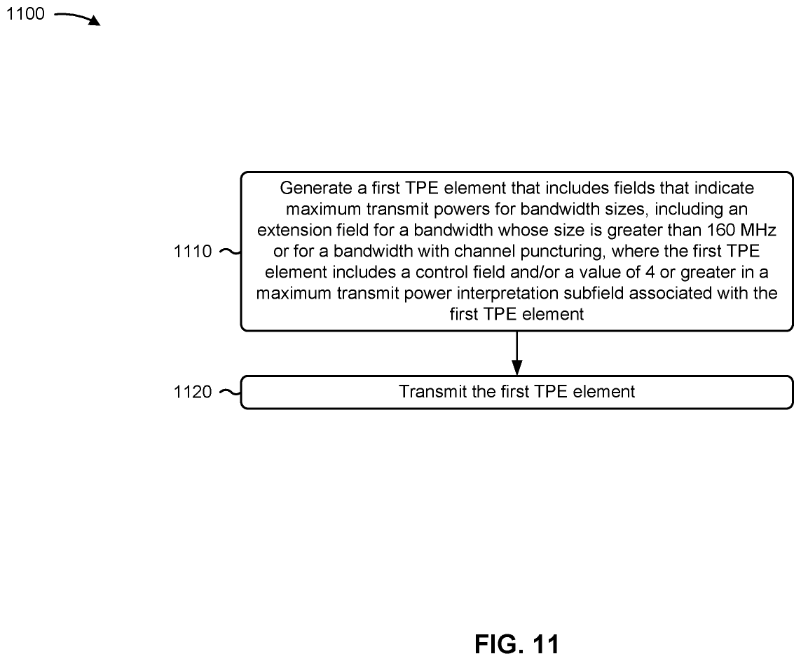

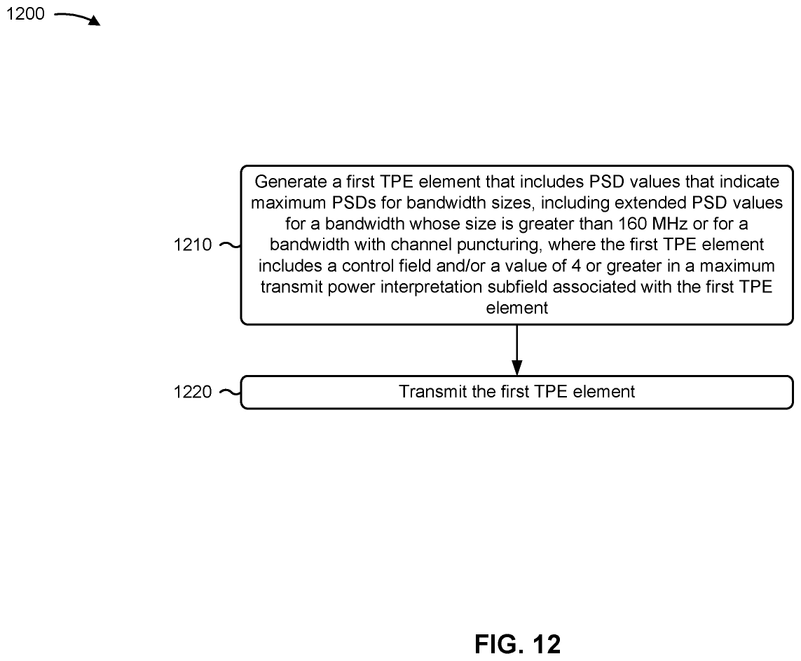

A controller/processor of a network entity (e.g., the controller/processor 240 of base station or AP 110), the controller/processor 280 of a wireless device (e.g., a UE 120), and/or any other component(s) of FIG. 2 may perform one or more techniques associated with indicating maximum transmit powers above 160 MHz, as described in more detail elsewhere herein. For example, the controller/processor 240 of the base station or AP 110 or the access point, the controller/processor 280 of the UE 120, and/or any other component(s) of FIG. 2 may perform or direct operations of, for example, process 700 of FIG. 7, process 800 of FIG. 8, process 900 of FIG. 9, process 1000 of FIG. 10, 1100 of FIG. 11, process 1200 of FIG. 12, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 700 of FIG. 7, process 800 of FIG. 8, process 900 of FIG. 9, process 1000 of FIG. 10, 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a network entity (e.g., base station or AP 110) includes means for generating a TPE element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode; and/or means for transmitting the TPE element. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a wireless device (e.g., a UE 120, a STA) includes means for receiving a TPE element that includes fields that indicate maximum transmit powers for bandwidth sizes, including an extension field for a bandwidth whose size is greater than 160 MHz or for a bandwidth with channel puncturing; means for decoding the extension field of the TPE element based at least in part on a first bandwidth size configured for the wireless device, whether the first bandwidth size includes channel puncturing, or one or more parameters in the TPE element; and/or means for transmitting a communication using a maximum transmit power indicated in the extension field. In some aspects, the means for the wireless device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for generating a TPE element that includes PSD values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode; and/or means for transmitting the TPE element.

In some aspects, the wireless device includes means for receiving a TPE element that includes PSD values that indicate maximum PSDs for bandwidth sizes, including extended PSD values for a bandwidth whose size is greater than 160 MHz or for a bandwidth with channel puncturing; means for decoding the extended PSD values of the TPE element based at least in part on a first bandwidth size configured for the wireless device, whether the first bandwidth size includes channel puncturing, or one or more parameters in the TPE element; and/or means for transmitting a communication using maximum transmit PSDs indicated by the extended PSD values.

In some aspects, the network entity includes means for generating a first TPE element that includes one or more fields that indicate maximum transmit powers for bandwidth sizes, including a field for a bandwidth whose size is greater than 160 MHz or for a bandwidth with channel puncturing, where the first TPE element includes one or more of a control field or a value of 4 or greater in a maximum transmit power interpretation subfield associated with the first TPE element; and/or means for transmitting the first TPE element.

In some aspects, the network entity includes means for generating a first TPE element that includes PSD values that indicate maximum PSDs for bandwidth sizes, including PSD values for a bandwidth whose size is greater than 160 MHz or for a bandwidth with channel puncturing, where the first TPE element includes one or more of a control field or a value of 4 or greater in a maximum transmit power interpretation subfield associated with the first TPE element; and/or means for transmitting the first TPE element

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

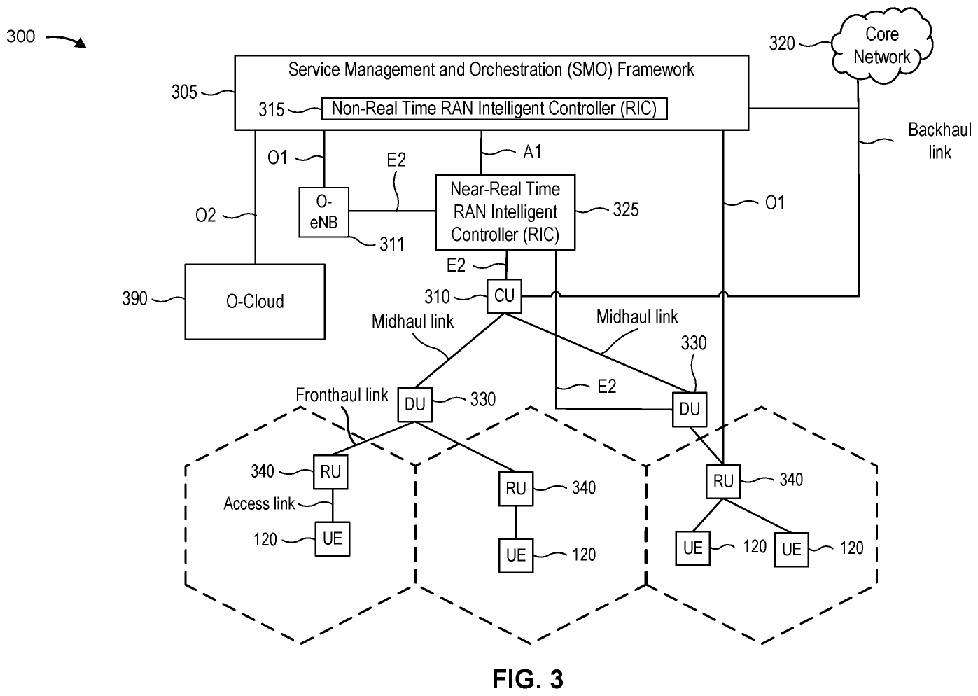

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, AP, a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit—User Plane (CU-UP)), control plane functionality (i.e., Central Unit—Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of a TPE format, in accordance with the present disclosure.

A network entity, such as an AP, and UEs, such as STAs, may communicate within a bandwidth using a transmit power. The transmit power may be limited within the bandwidth to manage power and interference. For example, the network entity may be configured to support bandwidth sizes up to 160 MHz in IEEE standard 802.11ax. These bandwidth sizes may be applicable to a high efficiency (HE) basic service set (BSS) operation mode. Example 400 shows an example of a TPE format 402, which includes octets indicating an element identifier (ID), a length, transmit power information, and a maximum transmit power. A transmit power information field format 404 for the transmit power information may include bits that indicate a maximum transfer power count, a maximum transmit power interpretation, and a maximum transmit power category. The maximum transmit power interpretation subfield encoding 406 for the maximum transmit power interpretation field may indicate a value identifying whether the maximum transmit power is an effective isotropic radiated power (EIRP) or an EIRP PSD.

If the value in the maximum transmit power interpretation subfield is 0 (zero) or 2, the maximum transmit power may be determined according to values in the meaning of the maximum transmit power count subfield for 0 or 2 408. A maximum transmit power field format for 0 or 2 410 shows bandwidths for which a maximum transmit power applies.

If the value in the maximum transmit power interpretation subfield is 1 or 3, the maximum transmit power PSD may be determined according to values in the meaning of the maximum transmit power count subfield for 1 or 3 412. A maximum transmit power field format for 1 or 3 414 shows PSD values.

In some scenarios, if the AP operates in an extremely high throughput (EHT) BSS operation mode, the AP may support bandwidth sizes greater than 160 MHz (e.g., up to 320 MHz) in IEEE 802.11be, including with puncturing. One or more subchannels within a bandwidth are punctured if a signal or information (e.g., bits) is cancelled and/or a different signal or information is inserted in the one or more subchannels. However, current TPE elements do not support bandwidths whose size is greater than 160 MHz, and future bandwidth sizes may include even wider bandwidths, such as 640 MHz (320 MHz+320 MHz) in 6 GHz or wider. Wider bandwidths may be used in 60 GHz in future 802.11 standards. Because a TPE element is transmitted in a management frame, such as a beacon, the TPE element size is constrained in order to minimize beacon bloating. Also, if there are any changes to the TPE element, the design is to be backward and forward compatible. Furthermore, if a bandwidth is punctured, values for the punctured bandwidth and values after the punctured bandwidth may not be correctly decoded by existing devices. Without proper support for indicating maximum transmit powers for bandwidths greater than 160 MHz and for punctured bandwidths, communications may be degraded and signaling resources may be wasted.

As indicated above, FIG. 4 is provided as an example. Other examples may differ from what is described with regard to FIG. 4.

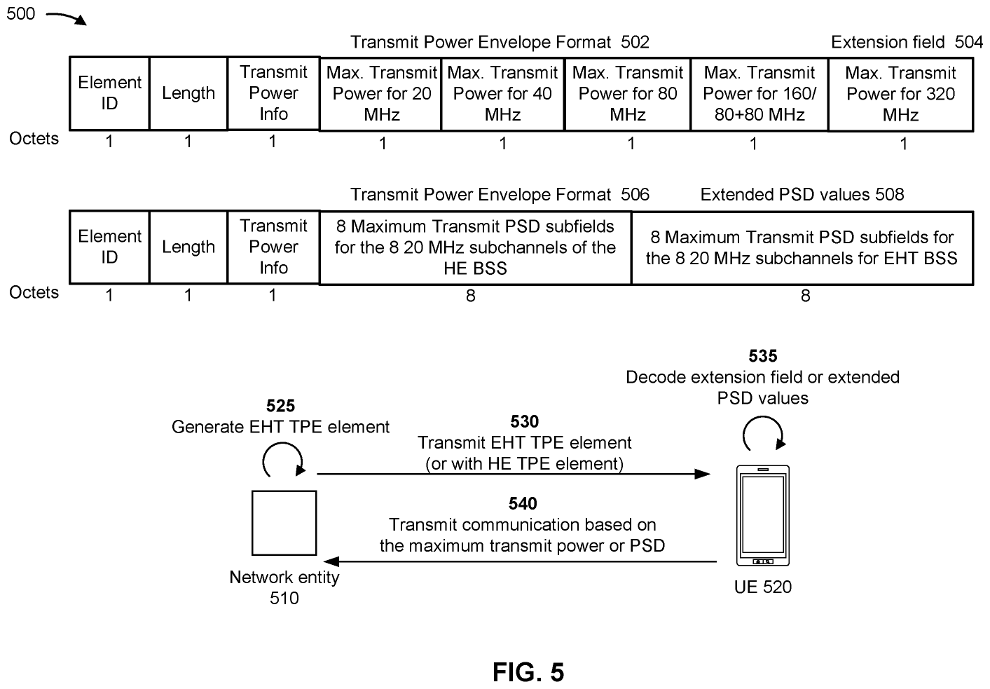

FIG. 5 is a diagram illustrating an example 500 of indicating a maximum transmit power for bandwidths with a size greater than 160 MHz or for a bandwidth that is punctured, in accordance with the present disclosure.

According to various aspects described herein, a network entity may generate a TPE element that can indicate a maximum transmit power for bandwidth sizes greater than 160 MHz or for a bandwidth that is punctured. The network entity may generate this new TPE element if the network entity detects a difference between a first bandwidth size configured for a first device operation mode (e.g., EHT BSS) and a second bandwidth size configured for a second device operation mode (e.g., HE BSS). That is, the network entity may generate the new TPE because the network entity's EHT BSS is configured to use a wider bandwidth than the network entity's HE BSS. The first device operation mode and the second device operation mode may each correspond to a specified configuration for bandwidth sizes, a device class, and/or a device capability. While a TPE element described herein may refer to a specified format, such as shown in FIGS. 4-6, the term “TPE element” may also represent transmit power information more generally or other element formats for other RATs.

In some aspects, depending on a maximum transmit power interpretation, the network entity may append a field (extension field) to the TPE element for a bandwidth whose size is greater than 160 MHz or may append PSD values (extended PSD values) for a bandwidth whose size is greater than 160 MHz. The extension field and the extended PSD values may also be used for a punctured bandwidth, where one or more 20 MHz subchannels of the bandwidth are punctured.

An HE TPE element may be composed based on the operating channel bandwidth of the HE BSS managed by the network entity 510. Example 500 shows a TPE format 502, similar to TPE format 402 in FIG. 4, with maximum transmit power values for a bandwidth of 20 MHz, for a bandwidth of 40 MHz, for a bandwidth of 80 MHz, and for a bandwidth of 160 MHz. However, TPE format 502 may account for EHT specific information and includes an extension field 504 for a maximum transmit power for 320 MHz. The extension field 504 may be a field that extends or adds to the existing fields in the TPE format for HE BSS. The network entity 510 may use the extension field 504 if the TPE element indicates a value of 0 or 2 in a maximum transmit power interpretation subfield associated with the TPE element.

Example 500 also shows a TPE format 506 with maximum transmit PSD values for the 8 20 MHz subchannels of the HE BSS. TPE format 506 may include extended PSD values 508. The extended PSD values 508 may be considered PSD values that extend or add to an existing field in the TPE format for HE BSS. The extended PSD values 508 may include 8 maximum transmit PSD values for the 8 20 MHz subchannels for EHT BSS. For example, if the network entity 510 has an EHT BSS that operates at 320 MHz while the network entity's HE BSS operates at 160 MHz, the network entity 510 may generate a TPE element that indicates per-20 MHz subchannel PSD values, including the extended PSD values 508 for 20 MHz subchannels above 160 MHz. The network entity 510 may use the extended PSD values 508 if the TPE element indicates a value of 1 or 3 in a maximum transmit power interpretation subfield associated with the TPE element.

The network entity 510 may increase a value in the length field of the TPE element to account for the extension field 504 (e.g., length increased to 6) or to account for the extended PSD values 508 (e.g., length increased to 17). The location and size of the extension field 504 and the extended PSD values 508 may vary according to different designs.

Example 500 shows an example of a network entity 510 (e.g., base station or AP 110) that may communicate with a UE 520 (e.g., UE 120) and control a transmit power of the UE 520. As shown by reference number 525, the network entity 510 may generate the TPE element with an extension field 504 or extended PSD values 508. The network entity 510 may list one or more values for one or more bandwidths in the extension field 504 in increasing bandwidth order. The network entity 510 may list the extended PSD values 508 in a frequency order, such as according to increasing frequencies. The extension field 504 and the extended PSD values 508 may include one or more values for a bandwidth size of 320 MHz or for a bandwidth size greater than 320 MHz (e.g., 640 MHz, 1.28 GHz).

As shown by reference number 530, the network entity 510 may transmit the TPE element. The network entity may transmit the TPE element in a management frame, such as a beacon or a probe response frame.

As shown by reference number 535, the UE 520, as an example of a receiving device, may decode the extension field 504 or the extended PSD values 508. The UE 520 may decode the extension field 504 or the extended PSD values 508 based at least in part on a first bandwidth size configured for the wireless device, whether the first bandwidth size includes channel puncturing, or one or more parameters in the TPE element. For example, the network entity 510 may decode the extension field 504 or the extended PSD values 508 if the UE 520 is operating in a first device operation mode (e.g., EHT BSS) that is configured with a first bandwidth size that is greater than a second bandwidth size that is configured for a second device operation mode (e.g., HE BSS). The differences in bandwidth may be, for example, 320 MHz vs 160 MHz or 160 MHz vs 40 MHz.

In some aspects, the network entity 510 may decode the extension field 504 or the extended PSD values 508 if the UE 520 determines that a difference between the length field in the TPE element and a maximum transmit power count field in the TPE element satisfies a difference threshold. For example, in the case of decoding the extension field 504, there may be a gap between the size of the length field and the size of the maximum transmit power count field. If the length field indicates a value of 5 and the maximum transmit power count indicates a value of 3, the gap is 2. This may be considered a legacy gap for HE BSS. If the extension field 504 is used, the length field may be 6 and thus the gap may extend to 3. The difference threshold may be the 3 and thus the UE 520 may decode the extension field 504 if the gap between the length and the maximum transmit power count satisfies the difference threshold of 3.

Similarly, in the case of decoding the PSD values 508, there may be a gap between the size of the length field and a value N that is derived from the maximum transmit power count. If the length is 9 and N is 8, the legacy gap for HE BSS is 1. If the extended PSD values 508 are used, the length may be 17 and the gap may extend to 9. The difference threshold for the extended PSD values 508 may be greater than 1, such as 9. The UE 520 may decode the extended PSD values 508 if the gap between the length and the N satisfies the difference threshold for the extended PSD values 508.

In some aspects, the network entity 510 may set a value of the maximum transmit power count to 0 (zero) to apply a maximum transmit PSD to the whole bandwidth (all nonpunctured subchannels of the operating bandwidth). This would mean no change to TPE format 402 for HE BSS. The UE 520 may apply a maximum transmit power or a maximum transmit PSD to the whole bandwidth if the maximum transmit power count is set to 0.

Upon decoding the TPE element, including decoding the extension field 504 or the extended PSD values 508, the UE 520 may obtain a maximum transmit power for a bandwidth above 160 MHz or maximum PSD values for subchannels in a bandwidth above 160 MHz. As shown by reference number 540, the UE 520 may transmit a communication based at least in part on the maximum transmit power or maximum transmit PSDs obtained from the TPE element. This may include selecting a transmit power for bandwidths or subchannels that do not exceed the maximum transmit power or maximum transmit PSDs. The UE 520 may select to use the maximum transmit power or maximum transmit PSDs. By using the extension field 504 or the extended PSD values 508, the network entity 510 may indicate, and the UE 520 may use, a maximum transmit power or maximum transmit PSDs for a bandwidth higher than 160 MHz. As a result, the UE 520 and other receiving devices may avoid more interference, improve communications, conserve power, and conserve signaling resources when operating in an EHT BSS mode.

In some scenarios, the bandwidth may be punctured at one or more 20 MHz subchannels, and some bandwidths may not be feasible (temporarily) due to puncturing. The network entity 510 may refer to a disabled subchannel bitmap field (or similar), which is a bitmap (puncturing pattern) where the lowest numbered bit corresponds to the 20 MHz subchannel that lies within the BSS bandwidth and that has the lowest frequency of the set of all 20 MHz subchannels within the BSS bandwidth. Each successive bit in the bitmap corresponds to the next higher frequency 20 MHz subchannel. A bit in the bitmap is set to 1 to indicate that the corresponding 20 MHz subchannel is punctured and set to 0 to indicate that the corresponding 20 MHz subchannel is not punctured.

For example, a puncturing pattern may have values 0011 0000, where the 3rd and 4th 20 MHz subchannels marked by “1” are punctured. For the puncturing pattern of 0011 0000, assuming the leftmost subchannel is the primary channel, the HE BSS can only use a bandwidth up to 40 MHz (because the HE BSS requires contiguous bandwidth) and thus the HE BSS will only use 2 maximum transmit power values for 20 and 40 MHz, respectively.

In some aspects, the network entity 510 may indicate, and the UE 520 may use, a maximum transmit power or maximum transmit PSDs for a bandwidth that is punctured, if the puncturing pattern is valid for EHT BSS. Valid puncturing patterns may be defined for EHT BSS (e.g., Table 36-30 in IEEE standard 802.11be for 5-bit punctured channel indication for the non-OFDMA case in an EHT multi-user (MU) procedure protocol data unit (PPDU)). The network entity 510 may otherwise skip inserting values in the TPE element for EHT BSS for bandwidths if the puncturing pattern is invalid according to the 802.11be standards.

For example, if a puncturing pattern is 0000 1111 0000 0000 and valid (for EHT BSS), the network entity 510 may use 20 decibel milliwatts (dBm) for the 20 MHz and 40 MHz bandwidths and 23 dBm for the 80 MHz, 160 MHz and 320 MHz bandwidths. That is, the network entity 510 may indicate maximum transmit power values for only the 20 MHz and 40 MHz bandwidths for HE BSS as (20, 20), but may append 3 additional maximum transmit power values in the extension field for 80 MHz, 160 MHz and 320 MHz bandwidths for EHT BSS as (20, 20, 23, 23, 23). The last 3 additional maximum transmit power values may be only usable for the EHT BSS. As 0000 1111 is an invalid puncturing pattern for 160 MHz according to the 802.11be standards, in order to reduce the size of TPE element, the network entity 510 may skip the maximum transmit power value for 160 MHz and indicate only 4 maximum transmit power values in the TPE element for 20 MHz, 40 MHz, 80 MHz and 320 MHz bandwidths as (20, 20, 23, 23). In this case, the UE 520 may skip decoding the maximum transmit power value for the 160 MHz bandwidth in the TPE based on the operating bandwidth of the EHT BSS and puncturing pattern indicated by the network entity 510. As a result, the network entity 510 and the UE 520 may improve communications over a larger bandwidth while conserving power and signaling resources. For forward compatibility, the network entity 510 may insert a control field in the beginning of the extension field 504 or of the extended PSD values field 508. Forward compatibility may mean that the control field can be used by UE 520 or a station that supports the EHT BSS operation mode to decode the TPE element. The control field may allow UE 520 to interpret the subsequent values in the extension field 504 or in the extended PSD values field 508 in a different way.

As indicated above, FIG. 5 is provided as an example. Other examples may differ from what is described with regard to FIG. 5.

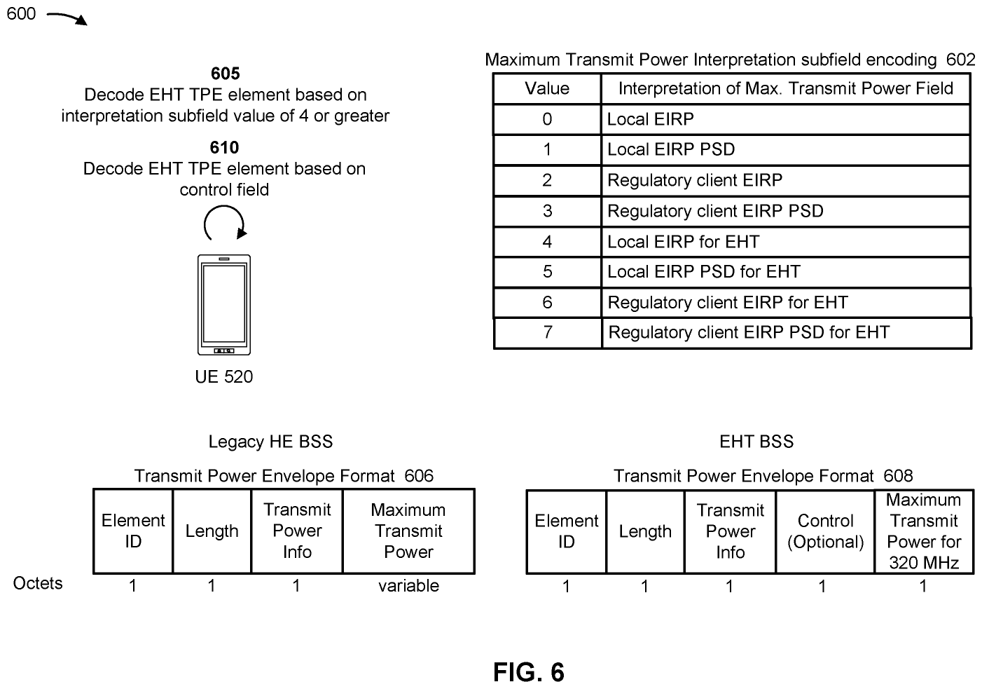

FIG. 6 is a diagram illustrating another example 600 of indicating a maximum transmit power for bandwidths with a size greater than 160 MHz or for a bandwidth that is punctured, in accordance with the present disclosure.

In some aspects, rather than adding the extension field 504 or the extended PSD values 508, the network entity 510 may transmit two TPE elements, one legacy TPE element for HE BSS and one new TPE element for EHT BSS that indicates values for newer standards and for bandwidths greater than 160 MHz or that are punctured. The network entity 510 may transmit the two TPEs elements in the same management frame (e.g., beacon, response probe frame). The UE 520 may combine the two TPE elements to obtain complete information for the whole bandwidth.

In some aspects, the new EHT TPE element may include a value in the maximum transmit power interpretation field that is currently reserved (e.g., values 4-7). For example, maximum transmit power interpretation subfield encoding 602 may include separate values for an HE TPE element and an EHT TPE element. A value of 4 for EHT may correspond to a value of 0 for HE. A value of 5 (or 6) for EHT may correspond to a value of 2 for HE. A value of 6 (or 5) for EHT may correspond to a value of 1 for HE. A value of 7 for EHT may correspond to a value of 3 for HE. The network entity 510 may transmit the new TPE element for EHT and a TPE element for HE. As shown by reference number 605, the UE 520 may decode the new TPE element for EHT for a higher bandwidth or a punctured bandwidth if the value in the maximum transmit power interpretation subfield is 4 or greater. Once the maximum transmit power values of the new EHT TPE element are decoded, the UE 520 combines the maximum transmit power values from the corresponding HE TPE element to obtain the overall set of the maximum transmit power values.

Alternatively, the network entity 510 may add a control field to a new TPE element for EHT for forward compatibility. Example 600 shows an example TPE format 606 for a legacy HE TPE element and an example TPE format 608 for a new EHT TPE element with an added control field. The control field may be located, for example, prior to or at a beginning of the maximum transmit power field. The control field may indicate that the maximum transmit power field includes a maximum transmit power or maximum transmit PSDs for bandwidths above 160 MHz, such as for 320 MHz or for bandwidths with channel puncturing. TPE format 608 shows how the maximum transmit power for 320 MHz may be conveyed from the network entity 510 to the UE 520. The control field may provide for forward compatibility as the control field may generally indicate or specifically identify (using 1 octet) a new standard, configuration, or bandwidth size to which the maximum transmit power value belongs. Forward compatibility may mean that the control field can be used by UE 520 or a station that supports the EHT BSS operation mode to decode the TPE element. As shown by reference number 610, the UE 520 may decode the new TPE element for EHT for a higher bandwidth or a punctured bandwidth based at least in part on a presence of a control field in the TPE element or a value in the control field. TPE format 606 and TPE format 608 show how maximum transmit power values for a bandwidth whose size is greater than 160 MHz or for a bandwidth with channel puncturing are transmitted by combining an HE TPE and a corresponding EHT TPE when the maximum transmit power interpretation subfield of the HE TPE has a value of 0 or 2. Similarly, maximum transmit PSD values for a bandwidth whose size is greater than 160 MHz or for a bandwidth with channel puncturing can be transmitted by combining an HE TPE and a corresponding EHT TPE when the maxim transmit power interpretation subfield of the HE TPE has a value of 1 or 3.

As indicated above, FIG. 6 is provided as an example. Other examples may differ from what is described with regard to FIG. 6.

FIG. 7 is a diagram illustrating an example process 700 performed, for example, by a network entity, in accordance with the present disclosure. Example process 700 is an example where the network entity (e.g., network entity 510) performs operations associated with indicating a maximum transmit power for bandwidths above 160 MHz or for punctured bandwidths.

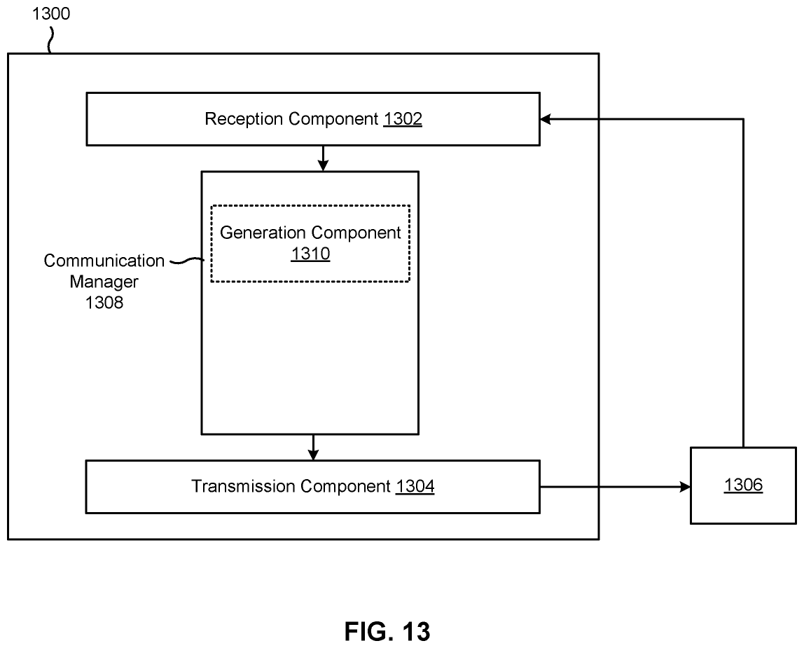

As shown in FIG. 7, in some aspects, process 700 may include generating a TPE element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode (block 710). For example, the network entity (e.g., using communication manager 1308 and/or generation component 1310 depicted in FIG. 13) may generate a TPE element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode, as described above.

As further shown in FIG. 7, in some aspects, process 700 may include transmitting the TPE element (block 720). For example, the network entity (e.g., using communication manager 1308 and/or transmission component 1304 depicted in FIG. 13) may transmit the TPE element, as described above.

Process 700 may include additional aspects, such as any single aspect or any combination of aspects described below and/or in connection with one or more other processes described elsewhere herein.

In a first aspect, generating the TPE element includes indicating a value of 0 or 2 in a maximum transmit power interpretation subfield associated with the TPE element.

In a second aspect, alone or in combination with the first aspect, process 700 includes increasing a value in a length field for the TPE element based at least in part on the extension field.

In a third aspect, alone or in combination with one or more of the first and second aspects, generating the TPE element includes generating the TPE element with one or more values for one or more bandwidths in the extension field, listed in increasing bandwidth order.

In a fourth aspect, alone or in combination with one or more of the first through third aspects, the extension field includes a value for a bandwidth size of 320 MHz.

In a fifth aspect, alone or in combination with one or more of the first through fourth aspects, the extension field includes a value for a bandwidth size greater than 320 MHz.

In a sixth aspect, alone or in combination with one or more of the first through fifth aspects, the first device operation mode includes an EHT BSS operation mode, and the second device operation mode includes an HE BSS operation mode. As mentioned above, there may be bandwidths or bandwidth sizes that are applicable to an EHT BSS operation mode and bandwidths or bandwidth sizes that are applicable to an HE BSS operation mode.

In a seventh aspect, alone or in combination with one or more of the first through sixth aspects, generating the TPE element includes excluding a transmit power value from a field that corresponds to a punctured bandwidth.

In an eighth aspect, alone or in combination with one or more of the first through seventh aspects, generating the TPE element includes indicating a value of 4 or greater in a maximum transmit power interpretation subfield associated with the TPE element.

In a ninth aspect, alone or in combination with one or more of the first through eighth aspects, generating the TPE element includes generating the TPE element with a control field for forward compatibility.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a wireless device, in accordance with the present disclosure. Example process 800 is an example where the wireless device (e.g., UE 520) performs operations associated with determining a maximum transmit power for bandwidths above 160 MHz or for punctured bandwidths.

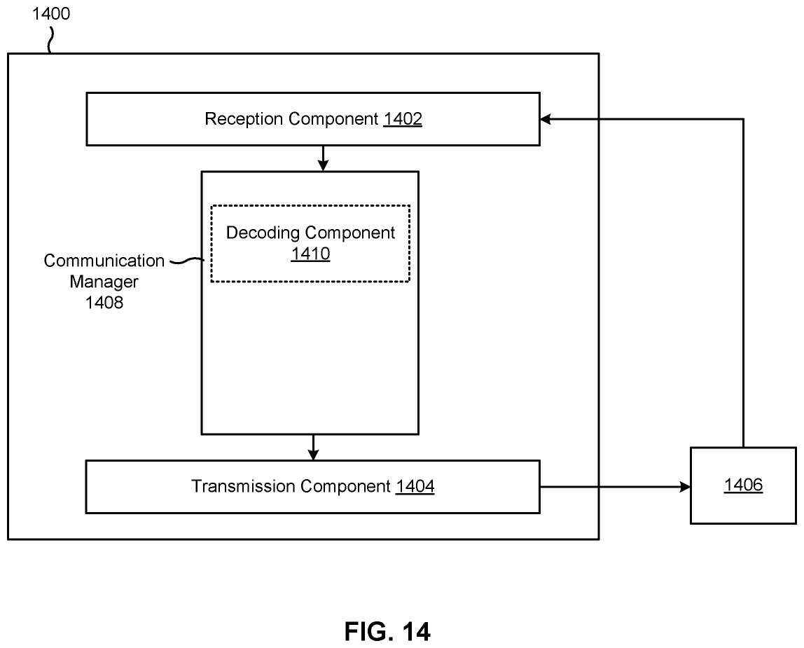

As shown in FIG. 8, in some aspects, process 800 may include receiving a TPE element that includes fields that indicate maximum transmit powers for bandwidth sizes, including an extension field for a bandwidth whose size is greater than 160 MHz or for a bandwidth with channel puncturing (block 810). For example, the wireless device (e.g., using communication manager 1408 and/or reception component 1402 depicted in FIG. 14) may receive a TPE element that includes fields that indicate maximum transmit powers for bandwidth sizes, including an extension field for a bandwidth whose size is greater than 160 MHz or for a bandwidth with channel puncturing, as described above.

As further shown in FIG. 8, in some aspects, process 800 may include decoding the extension field of the TPE element based at least in part on a first bandwidth size configured for the wireless device, whether the first bandwidth size includes channel puncturing, or one or more parameters in the TPE element (block 820). For example, the wireless device (e.g., using communication manager 1408 and/or decoding component 1410 depicted in FIG. 14) may decode the extension field of the TPE element based at least in part on a first bandwidth size configured for the wireless device, whether the first bandwidth size includes channel puncturing, or one or more parameters in the TPE element, as described above.

As further shown in FIG. 8, in some aspects, process 800 may include transmitting a communication using a maximum transmit power indicated in the extension field (block 830). For example, the wireless device (e.g., using communication manager 1408 and/or transmission component 1404 depicted in FIG. 14) may transmit a communication using a maximum transmit power indicated in the extension field, as described above.

Process 800 may include additional aspects, such as any single aspect or any combination of aspects described below and/or in connection with one or more other processes described elsewhere herein.

In a first aspect, decoding the extension field includes decoding the extension field in response to a determination that a maximum transmit power interpretation subfield associated with the TPE element has a value of 0 or 2.

In a second aspect, alone or in combination with the first aspect, decoding the extension field based at least in part on the first bandwidth size includes decoding the extension field in response to a determination that the wireless device is operating in a first device operation mode that is configured with the first bandwidth size, which is greater than a second bandwidth size that is configured for a second device operation mode.

In a third aspect, alone or in combination with one or more of the first and second aspects, the first device operation mode includes an EHT BSS operation mode, and the second device operation mode includes an HE BSS operation mode.

In a fourth aspect, alone or in combination with one or more of the first through third aspects, the extension field includes a value for a bandwidth size of 320 MHz.

In a fifth aspect, alone or in combination with one or more of the first through fourth aspects, the extension field includes a value for a bandwidth size greater than 320 MHz.

In a sixth aspect, alone or in combination with one or more of the first through fifth aspects, decoding the extension field based at least in part on the one or more parameters in the TPE element includes decoding the extension field in response to a determination that a difference between a length field in the TPE element and a maximum transmit power count field in the TPE element satisfies a difference threshold.

In a seventh aspect, alone or in combination with one or more of the first through sixth aspects, process 800 includes decoding the fields of the TPE element that correspond to bandwidths that have a valid puncturing pattern.

In an eighth aspect, alone or in combination with one or more of the first through seventh aspects, decoding the extension field includes decoding the extension field in response to a determination that a maximum transmit power interpretation subfield associated with the TPE element has a value of 4 or greater.

In a ninth aspect, alone or in combination with one or more of the first through eighth aspects, decoding the extension field includes decoding the extension field based at least in part on a control field associated with the extension field.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network entity UE 510) performs operations associated with indicating a maximum transmit power for bandwidths above 160 MHz or for punctured bandwidths.

As shown in FIG. 9, in some aspects, process 900 may include generating a TPE element that includes PSD values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode (block 910). For example, the network entity (e.g., using communication manager 1308 and/or generation component 1310 depicted in FIG. 13) may generate a TPE element that includes PSD values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode, as described above.

As further shown in FIG. 9, in some aspects, process 900 may include transmitting the TPE element (block 920). For example, the network entity (e.g., using communication manager 1308 and/or transmission component 1304 depicted in FIG. 13) may transmit the TPE element, as described above.

Process 900 may include additional aspects, such as any single aspect or any combination of aspects described below and/or in connection with one or more other processes described elsewhere herein.

In a first aspect, generating the TPE element includes indicating a value of 1 or 3 in a maximum transmit power interpretation subfield associated with the TPE element.

In a second aspect, alone or in combination with the first aspect, process 900 includes increasing a value in a length field for the TPE element based at least in part on the extended PSD values.

In a third aspect, alone or in combination with one or more of the first and second aspects, generating the TPE element includes generating the TPE element with the extended PSD values listed in frequency order.

In a fourth aspect, alone or in combination with one or more of the first through third aspects, the extended PSD values are for a bandwidth size of 320 MHz or a bandwidth size greater than 320 MHz.

In a fifth aspect, alone or in combination with one or more of the first through fourth aspects, the first device operation mode includes an EHT BSS operation mode, and the second device operation mode includes an HE BSS operation mode.

In a sixth aspect, alone or in combination with one or more of the first through fifth aspects, generating the TPE element includes excluding PSD values for punctured subchannels.

In a seventh aspect, alone or in combination with one or more of the first through sixth aspects, process 900 includes setting a value of a maximum transmit power count field to 0 or a specified value in response to a determination to apply a maximum PSD value to all non-punctured subchannels within the specified bandwith in the TPE element.

In an eighth aspect, alone or in combination with one or more of the first through seventh aspects, generating the TPE element includes indicating a value of 4 or greater in a maximum transmit power interpretation subfield associated with the TPE element.

In a ninth aspect, alone or in combination with one or more of the first through eighth aspects, generating the TPE element includes generating the TPE element with a control field for forward compatibility.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a wireless device, in accordance with the present disclosure. Example process 1000 is an example where the wireless device (e.g., UE 520) performs operations associated with determining a maximum transmit power for bandwidths above 160 MHz or for punctured bandwidths.

As shown in FIG. 10, in some aspects, process 1000 may include receiving a TPE element that includes PSD values that indicate maximum PSDs for bandwidth sizes, including extended PSD values for a bandwidth whose size is greater than 160 MHz or for a bandwidth with channel puncturing (block 1010). For example, the wireless device (e.g., using communication manager 1408 and/or reception component 1402 depicted in FIG. 14) may receive a TPE element that includes PSD values that indicate maximum PSDs for bandwidth sizes, including extended PSD values for a bandwidth whose size is greater than 160 MHz or for a bandwidth with channel puncturing, as described above.

As further shown in FIG. 10, in some aspects, process 1000 may include decoding the extended PSD values of the TPE element based at least in part on a first bandwidth size configured for the wireless device, whether the first bandwidth size includes channel puncturing, or one or more parameters in the TPE element (block 1020). For example, the wireless device (e.g., using communication manager 1408 and/or decoding component 1410 depicted in FIG. 14) may decode the extended PSD values of the TPE element based at least in part on a first bandwidth size configured for the wireless device, whether the first bandwidth size includes channel puncturing, or one or more parameters in the TPE element, as described above.

As further shown in FIG. 10, in some aspects, process 1000 may include transmitting a communication using maximum transmit PSDs indicated by the extended PSD values (block 1030). For example, the wireless device (e.g., using communication manager 1408 and/or transmission component 1404 depicted in FIG. 14) may transmit a communication using maximum transmit PSDs indicated by the extended PSD values, as described above.

Process 1000 may include additional aspects, such as any single aspect or any combination of aspects described below and/or in connection with one or more other processes described elsewhere herein.

In a first aspect, decoding the extended PSD values includes decoding the extended PSD values in response to a determination that a maximum transmit power interpretation subfield of the TPE element has a value of 1 or 3.

In a second aspect, alone or in combination with the first aspect, decoding the extended PSD values based at least in part on the first bandwidth size includes decoding the extended PSD values in response to a determination that the wireless device is operating in a first device operation mode that is configured with the first bandwidth size, which is greater than a second bandwidth size that is configured for a second device operation mode.

In a third aspect, alone or in combination with one or more of the first and second aspects, the first device operation mode includes an EHT BSS operation mode, and the second device operation mode includes an HE BSS operation mode.

In a fourth aspect, alone or in combination with one or more of the first through third aspects, decoding the extended PSD values based at least in part on the one or more parameters in the TPE element includes decoding the extended PSD values in response to a determination that a difference between a length field in the TPE element and a maximum transmit power count field in the TPE element satisfies a difference threshold.

In a fifth aspect, alone or in combination with one or more of the first through fourth aspects, the extended PSD values are for a bandwidth size of 320 MHz or a bandwidth size greater than 320 MHz.

In a sixth aspect, alone or in combination with one or more of the first through fifth aspects, process 1000 includes decoding the PSD values of the TPE element that correspond to bandwidths that have a valid puncturing pattern.

In a seventh aspect, alone or in combination with one or more of the first through sixth aspects, the extended PSD values are listed in frequency order.

In an eighth aspect, alone or in combination with one or more of the first through seventh aspects, process 1000 includes applying a maximum PSD value to all bandwidths in response to a determination that a value of a maximum transmit power count field in the TPE element is set to 0 or a specified value.

In a ninth aspect, alone or in combination with one or more of the first through eighth aspects, decoding the extended PSD values includes decoding the extended PSD values in response to a determination that a maximum transmit power interpretation subfield of the TPE element has a value of 4 or greater.

In a tenth aspect, alone or in combination with one or more of the first through ninth aspects, decoding the extended PSD values includes decoding the extended PSD values based at least in part on a control field associated with the extended PSD values.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network entity 510) performs operations associated with indicating a maximum transmit power for bandwidths above 160 MHz or for punctured bandwidths.

As shown in FIG. 11, in some aspects, process 1100 may include generating a first TPE element that includes one or more fields that indicate maximum transmit powers for bandwidth sizes, including a field for a bandwidth whose size is greater than 160 MHz or for a bandwidth with channel puncturing, wherein the first TPE element includes one or more of a control field or a value of 4 or greater in a maximum transmit power interpretation subfield associated with the first TPE element (block 1110). For example, the network entity (e.g., using communication manager 1308 and/or generation component 1310 depicted in FIG. 13) may generate a first TPE element that includes one or more fields that indicate maximum transmit powers for bandwidth sizes, including a field for a bandwidth whose size is greater than 160 MHz or for a bandwidth with channel puncturing, where the first TPE element includes one or more of a control field or a value of 4 or greater in a maximum transmit power interpretation subfield associated with the first TPE element, as described above.

As further shown in FIG. 11, in some aspects, process 1100 may include transmitting the first TPE element (block 1120). For example, the network entity (e.g., using communication manager 1308 and/or transmission component 1304 depicted in FIG. 13) may transmit the first TPE element, as described above.

Process 1100 may include additional aspects, such as any single aspect or any combination of aspects described below and/or in connection with one or more other processes described elsewhere herein.

In a first aspect, process 1100 includes generating a second TPE element that includes fields that indicate maximum transmit powers for bandwidths no greater in size than 160 MHz, and transmitting the first TPE element includes transmitting the first TPE element and the second TPE element in a management frame.

In a second aspect, alone or in combination with the first aspect, the management frame is a beacon or a probe response frame.

In a third aspect, alone or in combination with one or more of the first and second aspects, the value in the maximum transmit power interpretation subfield associated with the first TPE element is 4, and the value in the maximum transmit power interpretation subfield associated with the second TPE element is 0, or the value in the maximum transmit power interpretation subfield associated with the first TPE element is 5 or 6, and the value in the maximum transmit power interpretation subfield associated with the second TPE element is 2.

In a fourth aspect, alone or in combination with one or more of the first through third aspects, generating the first TPE element includes generating the first TPE element based at least in part on detecting a difference between a first bandwidth size configured for a first device operation mode and a second bandwidth size configured for a second device operation mode.

In a fifth aspect, alone or in combination with one or more of the first through fourth aspects, the first device operation mode includes an EHT BSS operation mode, and the second device operation mode includes an HE BSS operation mode.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network entity, in accordance with the present disclosure. Example process 1200 is an example where the network entity (e.g., network entity 510) performs operations associated with determining a maximum transmit power for bandwidths above 160 MHz or for punctured bandwidths.

As shown in FIG. 12, in some aspects, process 1200 may include generating a first TPE element that includes PSD values that indicate maximum PSDs for bandwidth sizes, including PSD values for a bandwidth whose size is greater than 160 MHz or for a bandwidth with channel puncturing, wherein the first TPE element includes a value of 4 or greater in a maximum transmit power interpretation subfield associated with the first TPE element (block 1210). For example, the network entity (e.g., using communication manager 1308 and/or generation component 1310 depicted in FIG. 13) may generate a first TPE element that includes PSD values that indicate maximum PSDs for bandwidth sizes, including PSD values for a bandwidth whose size is greater than 160 MHz or for a bandwidth with channel puncturing, wherein the first TPE element includes a value of 4 or greater in a maximum transmit power interpretation subfield associated with the first TPE element, as described above.

As further shown in FIG. 12, in some aspects, process 1200 may include transmitting the first TPE element (block 1220). For example, the network entity (e.g., using communication manager 1308 and/or transmission component 1304 depicted in FIG. 13) may transmit the first TPE element, as described above.

Process 1200 may include additional aspects, such as any single aspect or any combination of aspects described below and/or in connection with one or more other processes described elsewhere herein.

In a first aspect, process 1200 includes generating a second TPE element that includes PSD values that indicate maximum transmit powers for bandwidths no greater in size than 160 MHz, and transmitting the first TPE element includes transmitting the first TPE element and the second TPE element in a management frame.

In a second aspect, alone or in combination with the first aspect, the management frame is a beacon or a probe response frame.

In a third aspect, alone or in combination with one or more of the first and second aspects, the value in the maximum transmit power interpretation subfield associated with the first TPE element is 5 or 6, and the value in the maximum transmit power interpretation subfield associated with the second TPE element is 1, or the value in the maximum transmit power interpretation subfield associated with the first TPE element is 6 or 7, and the value in the maximum transmit power interpretation subfield associated with the second TPE element is 3.

In a fourth aspect, alone or in combination with one or more of the first through third aspects, generating the first TPE element includes generating the first TPE element based at least in part on detecting a difference between a first bandwidth size configured for a first device operation mode and a second bandwidth size configured for a second device operation mode.

In a fifth aspect, alone or in combination with one or more of the first through fourth aspects, the first device operation mode includes an EHT BSS operation mode, and the second device operation mode includes an HE BSS operation mode.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a network entity (e.g., base station or AP 110, network entity 510), or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, AP, network entity, STA, or another wireless communication device) using the reception component 1302 and the transmission component 1304. As further shown, the apparatus 1300 may include the communication manager 1308. The communication manager 1308 may control and/or otherwise manage one or more operations of the reception component 1302 and/or the transmission component 1304. In some aspects, the communication manager 1308 may include one or more antennas, a modem, a controller/processor, a memory, or a combination thereof, of the base station or AP described in connection with FIG. 2. The communication manager 1308 may be, or be similar to, the communication manager 150 depicted in FIGS. 1 and 2. For example, in some aspects, the communication manager 1308 may be configured to perform one or more of the functions described as being performed by the communication manager 150. In some aspects, the communication manager 1308 may include the reception component 1302 and/or the transmission component 1304. The communication manager 1308 may include a generation component 1310, among other examples.

In some aspects, the apparatus 1300 may be configured to perform one or more operations described herein in connection with FIGS. 1-6. Additionally, or alternatively, the apparatus 1300 may be configured to perform one or more processes described herein, such as process 700 of FIG. 7, process 900 of FIG. 9, process 1100 of FIG. 11, or a combination thereof. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network entity described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the network entity described in connection with FIG. 2. In some aspects, the transmission component 1304 may be co-located with the reception component 1302 in a transceiver.

The generation component 1310 may generate a TPE element that includes fields that indicate maximum transmit powers for bandwidth sizes, including an extension field for a bandwidth whose size is greater than 160 MHz or for a bandwidth with channel puncturing, based at least in part on detecting a difference between a first bandwidth size configured for a first device operation mode and a second bandwidth size configured for a second device operation mode. The transmission component 1304 may transmit the TPE element. The generation component 1310 may increase a value in a length field for the TPE element based at least in part on the extension field.

The generation component 1310 may generate a TPE element that includes PSD values that indicate maximum PSDs for bandwidth sizes, including extended PSD values for a bandwidth whose size is greater than 160 MHz or for a bandwidth with channel puncturing, based at least in part on detecting a difference between a first bandwidth size configured for a first device operation mode and a second bandwidth size configured for a second device operation mode. The transmission component 1304 may transmit the TPE element.

The generation component 1310 may increase a value in a length field for the TPE element based at least in part on the extended PSD values. The generation component 1310 may set a value of a maximum transmit power count field to 0 or a specified value in response to a determination to apply a maximum PSD value to all non-punctured subchannels within the bandwidth specified in the TPE element.

The generation component 1310 may generate a first TPE element that includes one or more fields that indicate maximum transmit powers for bandwidth sizes, including a field for a bandwidth whose size is greater than 160 MHz or for a bandwidth with channel puncturing, where the first TPE element includes one or more of a control field and/or a value of 4 or greater in a maximum transmit power interpretation subfield associated with the first TPE element. The transmission component 1304 may transmit the first TPE element.

The generation component 1310 may generate a second TPE element that includes fields that indicate maximum transmit powers for bandwidths no greater in size than 160 MHz, where transmitting the first TPE element includes transmitting the first TPE element and the second TPE element in a management frame.

The generation component 1310 may generate a first TPE element that includes PSD values that indicate maximum PSDs for bandwidth sizes, including extended PSD values for a bandwidth whose size is greater than 160 MHz or for a bandwidth with channel puncturing, where the first TPE element includes one or more of a control field and/or a value of 4 or greater in a maximum transmit power interpretation subfield associated with the first TPE element. The transmission component 1404 may transmit the first TPE element.

The generation component 1310 may generate a second TPE element that includes PSD values that indicate maximum transmit powers for bandwidths no greater in size than 160 MHz, where transmitting the first TPE element includes transmitting the first TPE element and the second TPE element in a management frame.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a wireless device (e.g., a UE 120, UE 520), or a wireless device may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, an AP, a network entity, a STA, or another wireless communication device) using the reception component 1402 and the transmission component 1404. As further shown, the apparatus 1400 may include the communication manager 1408. The communication manager 1408 may control and/or otherwise manage one or more operations of the reception component 1402 and/or the transmission component 1404. In some aspects, the communication manager 1408 may include one or more antennas, a modem, a controller/processor, a memory, or a combination thereof, of the UE described in connection with FIG. 2. The communication manager 1408 may be, or be similar to, the communication manager 150 depicted in FIGS. 1 and 2. For example, in some aspects, the communication manager 1408 may be configured to perform one or more of the functions described as being performed by the communication manager 150. In some aspects, the communication manager 1408 may include the reception component 1402 and/or the transmission component 1404. The communication manager 1408 may include a decoding component 1410, among other examples.

In some aspects, the apparatus 1400 may be configured to perform one or more operations described herein in connection with FIGS. 1-6. Additionally, or alternatively, the apparatus 1400 may be configured to perform one or more processes described herein, such as process 800 of FIG. 8, process 1000 of FIG. 10, process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive a TPE element that includes fields that indicate maximum transmit powers for bandwidth sizes, including an extension field for a bandwidth whose size is greater than 160 MHz or for a bandwidth with channel puncturing. The decoding component 1410 may decode the extension field of the TPE element based at least in part on a first bandwidth size configured for the wireless device, whether the first bandwidth size includes channel puncturing, or one or more parameters in the TPE element. The transmission component 1404 may transmit a communication using a maximum transmit power indicated in the extension field. The decoding component 1410 may decode the fields of the TPE element that correspond to bandwidths that have a valid puncturing pattern.

The reception component 1402 may receive a TPE element that includes PSD values that indicate maximum PSDs for bandwidth sizes, including extended PSD values for a bandwidth whose size is greater than 160 MHz or for a bandwidth with channel puncturing. The decoding component 1410 may decode the extended PSD values of the TPE element based at least in part on a first bandwidth size configured for the wireless device, whether the first bandwidth size includes channel puncturing, or one or more parameters in the TPE element. The transmission component 1404 may transmit a communication using maximum transmit PSDs indicated by the extended PSD values.

The decoding component 1410 may decode the PSD values of the TPE element that correspond to bandwidths that have a valid puncturing pattern. The transmission component 1404 may apply a maximum PSD value to all bandwidths in response to a determination that a value of a maximum transmit power count field in the TPE element is set to 0 or a specified value.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a network entity, comprising: generating a transmit power envelope (TPE) element that includes fields that indicate maximum transmit powers for bandwidth sizes, including an extension field for a bandwidth whose size is greater than 160 megahertz (MHz) or for a bandwidth with channel puncturing, based at least in part on detecting a difference between a first bandwidth size configured for a first device operation mode and a second bandwidth size configured for a second device operation mode; and transmitting the TPE element.

Aspect 2: The method of Aspect 1, wherein generating the TPE element includes indicating a value of 0 or 2 in a maximum transmit power interpretation subfield associated with the TPE element.

Aspect 3: The method of Aspect 1 or 2, further comprising increasing a value in a length field for the TPE element based at least in part on the extension field.

Aspect 4: The method of any of Aspects 1-3, wherein generating the TPE element includes generating the TPE element with one or more values for one or more bandwidths in the extension field, listed in increasing bandwidth order.

Aspect 5: The method of any of Aspects 1-4, wherein the extension field includes a value for a bandwidth size of 320 MHz.

Aspect 6: The method of any of Aspects 1-4, wherein the extension field includes a value for a bandwidth size greater than 320 MHz.

Aspect 7: The method of any of Aspects 1-6, wherein the first device operation mode includes an extremely high throughput (EHT) basis service set (BSS) operation mode, and the second device operation mode includes a high efficiency (HE) BSS operation mode.

Aspect 8: The method of any of Aspects 1-7, wherein generating the TPE element includes excluding a transmit power value from a field that corresponds to a punctured bandwidth.

Aspect 9: The method of any of Aspects 1-8, wherein generating the TPE element includes indicating a value of 4 or greater in a maximum transmit power interpretation subfield associated with the TPE element.

Aspect 10: The method of any of Aspects 1-9, wherein generating the TPE element includes generating the TPE element with a control field for forward compatibility.

Aspect 11: A method of wireless communication performed by a wireless device, comprising: receiving a transmit power envelope (TPE) element that includes fields that indicate maximum transmit powers for bandwidth sizes, including an extension field for a bandwidth whose size is greater than 160 megahertz (MHz) or for a bandwidth with channel puncturing; decoding the extension field of the TPE element based at least in part on a first bandwidth size configured for the wireless device, whether the first bandwidth size includes channel puncturing, or one or more parameters in the TPE element; and transmitting a communication using a maximum transmit power indicated in the extension field.

Aspect 12: The method of Aspect 11, wherein decoding the extension field includes decoding the extension field in response to a determination that a maximum transmit power interpretation subfield associated with the TPE element has a value of 0 or 2.

Aspect 13: The method of Aspect 11 or 12, wherein decoding the extension field based at least in part on the first bandwidth size includes decoding the extension field in response to a determination that the wireless device is operating in a first device operation mode that is configured with the first bandwidth size, which is greater than a second bandwidth size that is configured for a second device operation mode.

Aspect 14: The method of Aspect 13, wherein the first device operation mode includes an extremely high throughput (EHT) basis service set (BSS) operation mode, and the second device operation mode includes a high efficiency (HE) BSS operation mode.

Aspect 15: The method of any of Aspects 11-14, wherein the extension field includes a value for a bandwidth size of 320 MHz.

Aspect 16: The method of any of Aspects 11-14, wherein the extension field includes a value for a bandwidth size greater than 320 MHz.

Aspect 17: The method of any of Aspects 11-16, wherein decoding the extension field based at least in part on the one or more parameters in the TPE element includes decoding the extension field in response to a determination that a difference between a length field in the TPE element and a maximum transmit power count field in the TPE element satisfies a difference threshold.

Aspect 18: The method of any of Aspects 11-17, further comprising decoding the fields of the TPE element that correspond to bandwidths that have a valid puncturing pattern.

Aspect 19: The method of any of Aspects 11-18, wherein decoding the extension field includes decoding the extension field in response to a determination that a maximum transmit power interpretation subfield associated with the TPE element has a value of 4 or greater.

Aspect 20: The method of any of Aspects 11-19, wherein decoding the extension field includes decoding the extension field based at least in part on a control field associated with the extension field.

Aspect 21: A method of wireless communication performed by a network entity, comprising: generating a transmit power envelope (TPE) element that includes power spectral density (PSD) values that indicate maximum PSDs for bandwidth sizes, including extended PSD values for a bandwidth whose size is greater than 160 megahertz (MHz) or for a bandwidth with channel puncturing, based at least in part on detecting a difference between a first bandwidth size configured for a first device operation mode and a second bandwidth size configured for a second device operation mode; and transmitting the TPE element.

Aspect 22: The method of Aspect 21, wherein generating the TPE element includes indicating a value of 1 or 3 in a maximum transmit power interpretation subfield associated with the TPE element.

Aspect 23: The method of Aspect 21 or 22, further comprising increasing a value in a length field for the TPE element based at least in part on the extended PSD values.

Aspect 24: The method of any of Aspects 21-23, wherein generating the TPE element includes generating the TPE element with the extended PSD values listed in frequency order.

Aspect 25: The method of any of Aspects 21-24, wherein the extended PSD values are for a bandwidth size of 320 MHz or a bandwidth size greater than 320 MHz.

Aspect 26: The method of any of Aspects 21-25, wherein the first device operation mode includes an extremely high throughput (EHT) basis service set (BSS) operation mode, and the second device operation mode includes a high efficiency (HE) BSS operation mode.

Aspect 27: The method of any of Aspects 21-26, wherein generating the TPE element includes excluding PSD values for punctured subchannels.

Aspect 28: The method of any of Aspects 21-27, further comprising setting a value of a maximum transmit power count field to 0 or a specified value in response to a determination to apply a maximum PSD value to all non-punctured subchannels within the bandwidth specified in the TPE element.

Aspect 29: The method of any of Aspects 21-28, wherein generating the TPE element includes indicating a value of 4 or greater in a maximum transmit power interpretation subfield associated with the TPE element.

Aspect 30: The method of any of Aspects 21-29, wherein generating the TPE element includes generating the TPE element with a control field for forward compatibility.

Aspect 31: A method of wireless communication performed by a wireless device, comprising: receiving a transmit power envelope (TPE) element that includes power spectral density (PSD) values that indicate maximum PSDs for bandwidth sizes, including extended PSD values for a bandwidth whose size is greater than 160 megahertz (MHz) or for a bandwidth with channel puncturing; decoding the extended PSD values of the TPE element based at least in part on a first bandwidth size configured for the wireless device, whether the first bandwidth size includes channel puncturing, or one or more parameters in the TPE element; and transmitting a communication using maximum transmit PSDs indicated by the extended PSD values.

Aspect 32: The method of Aspect 31, wherein decoding the extended PSD values includes decoding the extended PSD values in response to a determination that a maximum transmit power interpretation subfield of the TPE element has a value of 1 or 3.

Aspect 33: The method of Aspect 31 or 32, wherein decoding the extended PSD values based at least in part on the first bandwidth size includes decoding the extended PSD values in response to a determination that the wireless device is operating in a first device operation mode that is configured with the first bandwidth size, which is greater than a second bandwidth size that is configured for a second device operation mode.

Aspect 34: The method of Aspect 33, wherein the first device operation mode includes an extremely high throughput (EHT) basis service set (BSS) operation mode, and the second device operation mode includes a high efficiency (HE) BSS operation mode.

Aspect 35: The method of any of aspects Aspect 31-34, wherein decoding the extended PSD values based at least in part on the one or more parameters in the TPE element includes decoding the extended PSD values in response to a determination that a difference between a length field in the TPE element and a maximum transmit power count field in the TPE element satisfies a difference threshold.

Aspect 36: The method of any of aspects Aspect 31-35, wherein the extended PSD values are for a bandwidth size of 320 MHz or a bandwidth size greater than 320 MHz.

Aspect 37: The method of any of aspects Aspect 31-36, further comprising decoding the PSD values of the TPE element that correspond to bandwidths that have a valid puncturing pattern.

Aspect 38: The method of any of aspects Aspect 31-37, wherein the extended PSD values are listed in frequency order.

Aspect 39: The method of any of aspects Aspect 31-38, further comprising applying a maximum PSD value to all bandwidths in response to a determination that a value of a maximum transmit power count field in the TPE element is set to 0 or a specified value.

Aspect 40: The method of any of aspects Aspect 31-39, wherein decoding the extended PSD values includes decoding the extended PSD values in response to a determination that a maximum transmit power interpretation subfield of the TPE element has a value of 4 or greater.

Aspect 41: The method of any of aspects Aspect 31-40, wherein decoding the extended PSD values includes decoding the extended PSD values based at least in part on a control field associated with the extended PSD values.

Aspect 42: A method of wireless communication performed by a network entity, comprising: generating a first transmit power envelope (TPE) element that includes one or more fields that indicate maximum transmit powers for bandwidth sizes, including a field for a bandwidth whose size is greater than 160 megahertz (MHz) or for a bandwidth with channel puncturing, wherein the first TPE element includes one or more of a control field or a value of 4 or greater in a maximum transmit power interpretation subfield associated with the first TPE element; and transmitting the first TPE element.

Aspect 43: The method of Aspect 42, further comprising generating a second TPE element that includes fields that indicate maximum transmit powers for bandwidths no greater in size than 160 MHz, and wherein transmitting the first TPE element includes transmitting the first TPE element and the second TPE element in a management frame.

Aspect 44: The method of Aspect 43, wherein the management frame is a beacon or a probe response frame.

Aspect 45: The method of Aspect 43 or 44, wherein the value in the maximum transmit power interpretation subfield associated with the first TPE element is 4, and the value in the maximum transmit power interpretation subfield associated with the second TPE element is 0; or the value in the maximum transmit power interpretation subfield associated with the first TPE element is 5 or 6, and the value in the maximum transmit power interpretation subfield associated with the second TPE element is 2.

Aspect 46: The method of any of Aspects 42-45, wherein generating the first TPE element includes generating the first TPE element based at least in part on detecting a difference between a first bandwidth size configured for a first device operation mode and a second bandwidth size configured for a second device operation mode.

Aspect 47: The method of Aspect 46, wherein the first device operation mode includes an extremely high throughput (EHT) basis service set (BSS) operation mode, and the second device operation mode includes a high efficiency (HE) BSS operation mode.

Aspect 48: A method of wireless communication performed by a network entity, comprising: generating a first transmit power envelope (TPE) element that includes power spectral density (PSD) values that indicate maximum PSDs for bandwidth sizes, including PSD values for a bandwidth whose size is greater than 160 megahertz (MHz) or for a bandwidth with channel puncturing, wherein the first TPE element includes one or more of a control field or a value of 4 or greater in a maximum transmit power interpretation subfield associated with the first TPE element; and transmitting the first TPE element.

Aspect 49: The method of Aspect 48, further comprising generating a second TPE element that includes PSD values that indicate maximum transmit powers for bandwidths no greater in size than 160 MHz, and wherein transmitting the first TPE element includes transmitting the first TPE element and the second TPE element in a management frame.

Aspect 50: The method of Aspect 49, wherein the management frame is a beacon or a probe response frame.

Aspect 51: The method of Aspect 49 or 50, wherein the value in the maximum transmit power interpretation subfield associated with the first TPE element is 5 or 6, and the value in the maximum transmit power interpretation subfield associated with the second TPE element is 1; or the value in the maximum transmit power interpretation subfield associated with the first TPE element is 6 or 7, and the value in the maximum transmit power interpretation subfield associated with the second TPE element is 3.

Aspect 52: The method of any of Aspects 48-51, wherein generating the first TPE element includes generating the first TPE element based at least in part on detecting a difference between a first bandwidth size configured for a first device operation mode and a second bandwidth size configured for a second device operation mode.

Aspect 53: The method of Aspect 52, wherein the first device operation mode includes an extremely high throughput (EHT) basis service set (BSS) operation mode, and the second device operation mode includes a high efficiency (HE) BSS operation mode.

Aspect 54: An apparatus for wireless communication at a device, comprising a processor; memory coupled with the processor; and instructions stored in the memory and executable by the processor to cause the apparatus to perform the method of one or more of Aspects 1-53.

Aspect 55: A device for wireless communication, comprising a memory and one or more processors coupled to the memory, the one or more processors configured to perform the method of one or more of Aspects 1-53.

Aspect 56: An apparatus for wireless communication, comprising at least one means for performing the method of one or more of Aspects 1-53.

Aspect 57: A non-transitory computer-readable medium storing code for wireless communication, the code comprising instructions executable by a processor to perform the method of one or more of Aspects 1-53.

Aspect 58: A non-transitory computer-readable medium storing a set of instructions for wireless communication, the set of instructions comprising one or more instructions that, when executed by one or more processors of a device, cause the device to perform the method of one or more of Aspects 1-53.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network entity for wireless communication, comprising:
a memory; and
one or more processors, coupled to the memory, configured to:
generate a transmit power envelope (TPE) element that includes fields that indicate maximum transmit powers for bandwidth sizes, including an extension field for a bandwidth whose size is greater than 160 megahertz (MHz) or for a bandwidth with channel puncturing, based at least in part on detecting a difference between a first bandwidth size configured for a first device operation mode and a second bandwidth size configured for a second device operation mode; and
transmit the TPE element.

2. The network entity of claim 1, wherein the one or more processors, to generate the TPE element, are configured to indicate a value of 0 or 2 in a maximum transmit power interpretation subfield associated with the TPE element.

3. The network entity of claim 1, wherein the one or more processors are configured to increase a value in a length field for the TPE element based at least in part on the extension field.

4. The network entity of claim 1, wherein the one or more processors, to generate the TPE element, are configured to generate the TPE element with one or more values for one or more bandwidths in the extension field, listed in increasing bandwidth order.

5. The network entity of claim 1, wherein the extension field includes a value for a bandwidth size of 320 MHz or a bandwidth size greater than 320 MHz.

6. The network entity of claim 1, wherein the first device operation mode includes an extremely high throughput (EHT) basis service set (BSS) operation mode, and the second device operation mode includes a high efficiency (HE) BSS operation mode.

7. The network entity of claim 1, wherein the one or more processors, to generate the TPE element, are configured to indicate a value of 4 or greater in a maximum transmit power interpretation subfield associated with the TPE element.

8. The network entity of claim 1, wherein the one or more processors, to generate the TPE element, are configured to generate the TPE element with a control field for forward compatibility.

9. A wireless device for wireless communication, comprising:
a memory; and
one or more processors, coupled to the memory, configured to:
receive a transmit power envelope (TPE) element that includes fields that indicate maximum transmit powers for bandwidth sizes, including an extension field for a bandwidth whose size is greater than 160 megahertz (MHz) or for a bandwidth with channel puncturing;
decode the extension field of the TPE element based at least in part on a first bandwidth size configured for the wireless device, whether the first bandwidth size includes channel puncturing, or one or more parameters in the TPE element; and
transmit a communication using a maximum transmit power indicated in the extension field.

10. The wireless device of claim 9, wherein the one or more processors, to decode the extension field, are configured to decode the extension field in response to a determination that a maximum transmit power interpretation subfield associated with the TPE element has a value of 0 or 2.

11. The wireless device of claim 9, wherein the one or more processors, to decode the extension field based at least in part on the first bandwidth size, are configured to decode the extension field in response to a determination that the wireless device is operating in a first device operation mode that is configured with the first bandwidth size, which is greater than a second bandwidth size that is configured for a second device operation mode.

12. The wireless device of claim 11, wherein the first device operation mode includes an extremely high throughput (EHT) basis service set (BSS) operation mode, and the second device operation mode includes a high efficiency (HE) BSS operation mode.

13. The wireless device of claim 9, wherein the extension field includes a value for a bandwidth size of 320 MHz or a bandwidth size greater than 320 MHz.

14. The wireless device of claim 9, wherein the one or more processors, to decode the extension field based at least in part on the one or more parameters in the TPE element, are configured to decode the extension field in response to a determination that a difference between a length field in the TPE element and a maximum transmit power count field in the TPE element satisfies a difference threshold.

15. The wireless device of claim 9, wherein the one or more processors are configured to decode the fields of the TPE element that correspond to bandwidths that have a valid puncturing pattern.

16. The wireless device of claim 9, wherein the one or more processors, to decode the extension field, are configured to decode the extension field in response to a determination that a maximum transmit power interpretation subfield associated with the TPE element has a value of 4 or greater.

17. The wireless device of claim 9, wherein the one or more processors, to decode the extension field, are configured to decode the extension field based at least in part on a control field associated with the extension field.

18. A network entity for wireless communication, comprising:
a memory; and
one or more processors, coupled to the memory, configured to:
generate a transmit power envelope (TPE) element that includes power spectral density (PSD) values that indicate maximum PSDs for bandwidth sizes, including extended PSD values for a bandwidth whose size is greater than 160 megahertz (MHz) or for a bandwidth with channel puncturing, based at least in part on detecting a difference between a first bandwidth size configured for a first device operation mode and a second bandwidth size configured for a second device operation mode; and
transmit the TPE element.

19. The network entity of claim 18, wherein the one or more processors, to generate the TPE element, are configured to indicate a value of 1 or 3 in a maximum transmit power interpretation subfield associated with the TPE element.

20. The network entity of claim 18, wherein the one or more processors are configured to increase a value in a length field for the TPE element based at least in part on the extended PSD values.

21. The network entity of claim 18, wherein the one or more processors, to generate the TPE element, are configured to generate the TPE element with the extended PSD values listed in frequency order.

22. The network entity of claim 18, wherein the extended PSD values are for a bandwidth size of 320 MHz or a bandwidth size greater than 320 MHz.

23. The network entity of claim 18, wherein the first device operation mode includes an extremely high throughput (EHT) basis service set (BSS) operation mode, and the second device operation mode includes a high efficiency (HE) BSS operation mode.

24. The network entity of claim 18, wherein the one or more processors, to generate the TPE element, are configured to exclude PSD values for punctured subchannels.

25. The network entity of claim 18, wherein the one or more processors are configured to set a value of a maximum transmit power count field to 0 or a specified value in response to a determination to apply a maximum PSD value to all non-punctured subchannels within the bandwidth specified in the TPE element.

26. The network entity of claim 18, wherein the one or more processors, to generate the TPE element, are configured to indicate a value of 4 or greater in a maximum transmit power interpretation subfield associated with the TPE element.

27. The network entity of claim 18, wherein the one or more processors, to generate the TPE element, are configured to generate the TPE element with a control field for forward compatibility.

28. A wireless device for wireless communication, comprising:
a memory; and
one or more processors, coupled to the memory, configured to:
receive a transmit power envelope (TPE) element that includes power spectral density (PSD) values that indicate maximum PSDs for bandwidth sizes, including extended PSD values for a bandwidth whose size is greater than 160 megahertz (MHz) or for a bandwidth with channel puncturing;
decode the extended PSD values of the TPE element based at least in part on a first bandwidth size configured for the wireless device, whether the first bandwidth size includes channel puncturing, or one or more parameters in the TPE element; and
transmit a communication using maximum transmit PSDs indicated by the extended PSD values.

29. The wireless device of claim 28, wherein the one or more processors, to decode the extended PSD values, are configured to decode the extended PSD values in response to a determination that a maximum transmit power interpretation subfield of the TPE element has a value of 1 or 3.

30. The wireless device of claim 28, wherein the one or more processors, to decode the extended PSD values based at least in part on the first bandwidth size, are configured to decode the extended PSD values in response to a determination that the wireless device is operating in a first device operation mode that is configured with the first bandwidth size, which is greater than a second bandwidth size that is configured for a second device operation mode.

31. The wireless device of claim 30, wherein the first device operation mode includes an extremely high throughput (EHT) basis service set (BSS) operation mode, and the second device operation mode includes a high efficiency (HE) BSS operation mode.

32. The wireless device of claim 28, wherein the one or more processors, to decode the extended PSD values based at least in part on the one or more parameters in the TPE element, are configured to decode the extended PSD values in response to a determination that a difference between a length field in the TPE element and a maximum transmit power count field in the TPE element satisfies a difference threshold.

33. The wireless device of claim 28, wherein the extended PSD values are for a bandwidth size of 320 MHz or a bandwidth size greater than 320 MHz.

34. The wireless device of claim 28, wherein the one or more processors are configured to decode the PSD values of the TPE element that correspond to bandwidths that have a valid puncturing pattern.

35. The wireless device of claim 28, wherein the extended PSD values are listed in frequency order.

36. The wireless device of claim 28, wherein the one or more processors are configured to apply a maximum PSD value to all bandwidths in response to a determination that a value of a maximum transmit power count field in the TPE element is set to 0 or a specified value.

37. The wireless device of claim 28, wherein the one or more processors, to decode the extended PSD values, are configured to decode the extended PSD values in response to a determination that a maximum transmit power interpretation subfield of the TPE element has a value of 4 or greater.

38. The wireless device of claim 28, wherein the one or more processors, to decode the extended PSD values, are configured to decode the extended PSD values based at least in part on a control field associated with the extended PSD values.

39. A network entity for wireless communication, comprising:
a memory; and
one or more processors, coupled to the memory, configured to:
generate a first transmit power envelope (TPE) element that includes one or more fields that indicate maximum transmit powers for bandwidth sizes, including a field for a bandwidth whose size is greater than 160 megahertz (MHz) or for a bandwidth with channel puncturing, wherein the first TPE element includes one or more of a control field or a value of 4 or greater in a maximum transmit power interpretation subfield associated with the first TPE element; and
transmit the first TPE element.

40. The network entity of claim 39, wherein the one or more processors are configured to generate a second TPE element that includes fields that indicate maximum transmit powers for bandwidths no greater in size than 160 MHz, and wherein transmitting the first TPE element includes transmitting the first TPE element and the second TPE element in a management frame.

41. The network entity of claim 40, wherein the management frame is a beacon or a probe response frame.

42. The network entity of claim 40, wherein the value in the maximum transmit power interpretation subfield associated with the first TPE element is 4, and the value in the maximum transmit power interpretation subfield associated with the second TPE element is 0; or the value in the maximum transmit power interpretation subfield associated with the first TPE element is 5 or 6, and the value in the maximum transmit power interpretation subfield associated with the second TPE element is 2.

43. The network entity of claim 39, wherein the one or more processors, to generate the first TPE element, are configured to generate the first TPE element based at least in part on detecting a difference between a first bandwidth size configured for a first device operation mode and a second bandwidth size configured for a second device operation mode.

44. The network entity of claim 43, wherein the first device operation mode includes an extremely high throughput (EHT) basis service set (BSS) operation mode, and the second device operation mode includes a high efficiency (HE) BSS operation mode.

45. A network entity for wireless communication, comprising:
a memory; and
one or more processors, coupled to the memory, configured to:
generate a first transmit power envelope (TPE) element that includes power spectral density (PSD) values that indicate maximum PSDs for bandwidth sizes, including PSD values for a bandwidth whose size is greater than 160 megahertz (MHz) or for a bandwidth with channel puncturing, wherein the first TPE element includes one or more of a control field or a value of 4 or greater in a maximum transmit power interpretation subfield associated with the first TPE element; and
transmit the first TPE element.

46. The network entity of claim 45, wherein the one or more processors are configured to generate a second TPE element that includes PSD values that indicate maximum transmit powers for bandwidths no greater in size than 160 MHz, and wherein transmitting the first TPE element includes transmitting the first TPE element and the second TPE element in a management frame.

47. The network entity of claim 46, wherein the management frame is a beacon or a probe response frame.

48. The network entity of claim 46, wherein the value in the maximum transmit power interpretation subfield associated with the first TPE element is 5 or 6, and the value in the maximum transmit power interpretation subfield associated with the second TPE element is 1; or the value in the maximum transmit power interpretation subfield associated with the first TPE element is 6 or 7, and the value in the maximum transmit power interpretation subfield associated with the second TPE element is 3.

49. The network entity of claim 45, wherein the one or more processors, to generate the first TPE element, are configured to generate the first TPE element based at least in part on detecting a difference between a first bandwidth size configured for a first device operation mode and a second bandwidth size configured for a second device operation mode.

50. The network entity of claim 49, wherein the first device operation mode includes an extremely high throughput (EHT) basis service set (BSS) operation mode, and the second device operation mode includes a high efficiency (HE) BSS operation mode.
